(19) United States
(12) Patent Application Publication
(10) Pub. No.: US 2014/0358840 A1
(43) Pub. Date: Dec. 4, 2014

(54) APPARATUS, SYSTEM AND METHOD FOR RISK INDICATOR CALCULATION FOR DRIVING BEHAVIOUR AND FOR RECONSTRUCTING A VEHICLE TRAJECTORY

(71) Applicant: PULSE FUNCTION F6 LTD, Foxrock, Dublin (IE)

(72) Inventors: Srdjan Tadic, Belgrade (RS); B Milan Vukajlovic, Belgrade (RS)

(73) Assignee: Pulse Function F6 LTD, Foxrock, Dublin (IE)

(21) Appl. No.: 14/371,925

(22) PCT Filed: Jan. 14, 2013
(86) PCT No.: PCT/EP2013/050604

§ 371 Date: Jul. 11, 2014

(30) Foreign Application Priority Data
Jan. 13, 2012 (RS) 2012/000001

(51) Int. Cl. G06N 5/04; G05B 15/02

(52) U.S. Cl. CPC G06N 5/04; G05B 15/02
USPC 706/52

(57) ABSTRACT

A first aspect relates to an apparatus, system and method for calculating a driving behaviour risk indicator for a driver of a vehicle. Said aspect involves obtaining a count of events occurring in each of a plurality of predetermined categories based on inputs from an inertial unit mounted on the vehicle, the inertial unit including a 3D inertial sensor with 3D gyroscope functionality, each event being indicative of at least one of dangerous and aggressive driving; and calculating a driving behaviour risk indicator based on the number of events in each category. According to a second aspect, an apparatus and method for reconstructing a vehicle trajectory is provided. Said aspect includes updating a sensor error model.

### FIELD OF THE INVENTION

The present invention is related to analyzing driving behaviours and to producing an indication of the risk inherent in a driver's behaviour.

### BACKGROUND OF THE INVENTION

Different drivers exhibit different behaviour when driving. Some drivers are more aggressive than others, and some tend to take greater risks in their driving behaviour. It would be desirable to provide feedback to drivers regarding how risky their driving behaviour is so that they can take remedial action and modify their driving behaviour.

Satellite navigation systems for determining the position of and navigation of a vehicle are well-known. The use of accident detectors comprising accelerometers is also known, as is the fitting of telematics units in vehicles. Such telematics units generally comprise a mobile phone/cell phone transceiver to communicate information about the vehicle between the telematics unit and a remote processing entity.

Moreover, there is known a device for calculating a risk indicator of a vehicle driver, which uses an accelerometer to detect the acceleration and deceleration values of a vehicle, a GPS to detect the position and speed of a vehicle, and a GSM/GPRS module to send the detected data to an operation centre that calculates the risk indicator for the vehicle driver.

However, such a system is relatively crude and the risk indicator is therefore only approximate. Moreover, it relies on GPS and sending data to a remote location and is therefore not self-contained.

### SUMMARY OF THE INVENTION

The present invention is intended to address the shortcomings of the known art and provide an accurate apparatus for calculating a driver behaviour risk indicator, which may be self-contained on the vehicle or be a distributed apparatus comprising a telematics unit on the vehicle and a remote processing entity.

According to a first aspect of the present invention, there is provided an apparatus for calculating a driving behaviour risk indicator for a driver of a vehicle, comprising:
a processing and control unit; and
a memory,
the apparatus being adapted to:
obtain a count of events occurring in each of a plurality of predetermined categories based on inputs from an inertial unit mounted on the vehicle, the inertial unit including a 3D inertial sensor with 3D gyroscope functionality, each event being indicative of at least one of dangerous and aggressive driving; and
calculate a driving behaviour risk indicator based on the number of events in each category.

Preferably, a respective weighting factor being stored in the memory for each category and the apparatus being adapted to calculate the driving behaviour risk indicator by applying the respective weighting factor to the number of events in each category.

Preferably, the apparatus is adapted to calculate the driving behaviour risk indicator based on the number of events occurring in a predetermined period.

The apparatus may be advantageously be adapted to calculate the driving behaviour risk indicator based on the duration of the predetermined period.

The apparatus may also be advantageously adapted to calculate the driving behaviour risk indicator based on the distance travelled during the predetermined period.

Preferably, the apparatus is adapted to calculate the driving behaviour risk indicator by:
obtaining the number of events occurring in a predetermined period in each category;
applying a respective weighting factor to the number of events occurring in the predetermined period in each category;
summing the weighted numbers of events in all categories to obtain a cumulative risk for the predetermined period;
determining the distance travelled by the vehicle during the predetermined period; and
dividing the cumulative risk by the distance travelled.

Preferably, the apparatus is adapted to modify the cumulative risk for the predetermined period based on the duration of the period.

Preferably, the apparatus is further adapted to modify the driving behaviour risk indicator based on environmental data.

In this case, the environmental data may include at least one of road data, temperature data, ambient weather data and geographical position data.

Preferably, the predetermined categories comprise any two or more of harsh cornering, over-steering, and evasive manoeuvring.

Preferably, the apparatus is mountable in a vehicle.

In this case, the apparatus may comprise the inertial unit and preferably further comprises a transmitter and a receiver for communicating with a remote processing entity.

Alternatively, the apparatus may be remote from the vehicle;
the events in each category being detected on the vehicle; and
the apparatus being adapted to obtain the count by receiving from the vehicle at least one of:
   data in respect of each event, and
   the count of events in each category.

Alternatively, the apparatus may be remote from the vehicle; and adapted to obtain the count by receiving and processing inputs from an inertial unit mounted on the vehicle.

In these cases, preferably the apparatus is adapted to obtain a count of events, occurring in each of a plurality of predetermined categories, for each of a plurality of different vehicles in a fleet and to determine driving behaviour risk indicator for the fleet.

In this case the apparatus is preferably further adapted to compare the driving behaviour risk indicator for a single vehicle with at least one of the driving behaviour risk indicator of the fleet and an alternatively obtained comparative driving behaviour risk indicator and/or to compare the driving behaviour risk indicator of the fleet with an alternatively obtained comparative driving behaviour risk indicator.

According to a further aspect of the present invention, there is further provided a system comprising a processing entity and a plurality of apparatuses as described above, the processing entity communicating with each of the plurality of apparatuses by means of a long range wireless network.

According to a further aspect of the present invention, there is provided a system comprising a plurality of telematics units mounted on respective vehicles and a remote processing unit, wherein:
the telematics units comprise an inertial sensor unit;
at least one of the remote processing entity and the telematics units is adapted to obtain a count of events occurring in each of a plurality of predetermined categories based on inputs from the inertial sensor unit, each event being indicative of at least one of dangerous and aggressive driving; and
the remote processing entity is adapted to calculate a combined driving behaviour risk indicator for the plurality of telematics units based on the number of events in each category.

Preferably, the inertial sensor unit includes a 3D inertial sensor with 3D gyroscope functionality.

Preferably, at least one of the remote processing entity and each telematics unit is adapted to calculate a driving behaviour risk indicator.

According to a further aspect of the present invention, there is provided a method of calculating a driving behaviour risk indicator for a driver of a vehicle, comprising:
detecting events occurring in each of a plurality of predetermined categories based on inputs from an inertial unit mounted on the vehicle, the inertial unit including a 3D inertial sensor with 3D gyroscope functionality, each event being indicative of at least one of dangerous and aggressive driving; and
calculating a driving behaviour risk indicator based on the number of events in each category.

According to a yet further aspect of the present invention, there is provided a method of determining a driving behaviour risk indicator for a plurality of vehicles, the method comprising
detecting events occurring in each of a plurality of predetermined categories based on inputs from an inertial unit mounted on each said vehicle, each event being indicative of at least one of dangerous and aggressive driving; and
calculating a driving behaviour risk indicator for the plurality of vehicles based on the number of events in each category.

Various preferred features of these methods are analogous to the preferred features of the apparatus and system described above.

The present invention further provides in another aspect an apparatus for use in reconstructing a vehicle trajectory, the apparatus comprising:
a processing and control unit; and
a memory,
the apparatus being adapted to:
store sets of data at first predetermined times, each set of data comprising outputs at the respective first predetermined time from an inertial unit mounted on the vehicle, the inertial unit including a 3D inertial sensor with 3D gyroscope functionality;
update a sensor error model at second predetermined times data based on external data and storing a plurality of sensor error models;
detect an event; and
update each set of data stored from the start of the event to a third predetermined time after the start of the event based on a stored sensor error model stored most recently before the start of the event; and

Preferably, the apparatus is further adapted to reconstruct the trajectory of the vehicle based on the updated sets of data.

Preferably, the event is a crash.

Preferably, wherein the third predetermined time is determined as one of a fixed period after the start of the event and a fixed period during which the variation in output signals from the inertial unit remains below a predetermined threshold.

Preferably, wherein the frequency with which the sets of data are stored at the first predetermined times is adjusted after detection of the event.

Preferably, the apparatus is further adapted to determine resting position data of the vehicle after the event based on external data, and to reconstruct the trajectory is based on the updated sets of data taking the determined end position as a starting point.

Preferably, the resting position data includes at least one of data relating to the attitude of the vehicle and satellite positioning data.

Preferably, the apparatus is further adapted to:
determine at least one of a calculated averaged position, a calculated averaged acceleration vector, and an averaged final heading using updated sets of data stored during a fixed period after detection of the event; and
base the reconstructing of the trajectory on the determination.

Preferably, the apparatus is further adapted to:
determine at least one of a calculated final pitch, a calculated final roll and a calculated final yaw calculated using updated sets of data stored during a fixed period after detection of the event; and
base the reconstructing of the trajectory on the determination.

Preferably, the apparatus is adapted to reconstruct the trajectory by calculating at least one of a vehicle position, speed and attitude for a plurality of the first predetermined periods after the event using the updated stored sets of data.

Preferably, the apparatus is further adapted to calculate an updated inertial sensor data set before updating the sensor error model set.

The present invention further provides a method of reconstructing a vehicle trajectory of a vehicle comprising:
storing sets of data at first predetermined times, each set of data comprising outputs at the respective first predetermined time from an inertial unit mounted on the vehicle, the inertial unit including a 3D inertial sensor with 3D gyroscope functionality;
updating a sensor error model at second predetermined times data based on external data and storing a plurality of sensor error models;
detecting an event;
updating each set of data stored from the start of the event to a third predetermined time after the start of the event based on a stored sensor error model stored most recently before the start of the event; and
reconstructing the trajectory of the vehicle based on the updated sets of data.

Various preferred features of these methods are analogous to the preferred features of the apparatus and system described above.

### BRIEF DESCRIPTION OF THE DRAWINGS

Embodiments of the present invention will now be described by way of further example only and with reference to the accompanying drawings, in which:

FIG. 1 is a schematic drawing of a telematics unit suitable for use in the present invention;

FIG. 2 is a schematic representation of a system suitable for use in the present invention;

FIG. 3 is a further schematic view of a telematics unit suitable for use in the present invention;

FIG. 4 is a schematic view of a 3D inertial sensor with 3D gyroscope functionality;

FIG. 5 is a flow diagram showing the determination of a harsh acceleration event;

FIG. 6 is a flow diagram showing the determination of a harsh braking event;

FIG. 7 is a flow diagram showing the determination of a harsh cornering event;

FIG. 8 is a flow diagram showing the determination of an over-steering event;

FIG. 9 is a flow diagram showing the determination of an evasive manoeuvre event;

FIG. 10 is a flow diagram showing the determination of a speed variance event;

FIG. 11 is a flow diagram showing the determination of the event of driving without a break for too long;

FIG. 12 is a diagram representing an overview of the calculation of a driving behaviour risk indicator for a vehicle;

FIG. 13 is a diagram representing the calculation of a driving behaviour risk indicator for a vehicle in more detail.

FIG. 14 is a schematic view of a system according to the present invention comprising a fleet of vehicles;

FIG. 15 is a diagram representing an overview of the calculation of a driving behaviour risk indicator for a fleet of vehicles;

FIG. 16 is a diagram representing the calculation of a driving behaviour risk indicator for a fleet of vehicles in more detail;

FIG. 17 is a flow diagram showing the determination of a non-severe crash event;

FIG. 18 is a flow diagram showing the determination of a severe crash event;

FIG. 19 shows a timeline of a crash useful for explaining vehicle trajectory reconstruction;

FIG. 20 is a flow diagram showing correction of the inertial sensor unit outputs;

FIG. 21 is a flow diagram showing the determination of vehicle trajectory; and

FIG. 22 is a flow diagram showing travel data recording.

### DETAILED DESCRIPTION

The present invention provides an apparatus, system and method for calculating a risk indicator for driving behaviour.

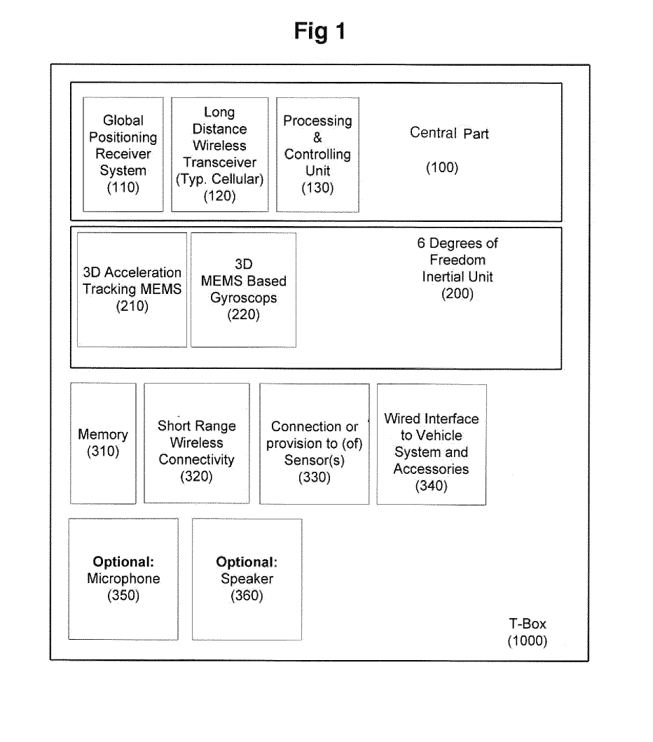

A first embodiment of the present invention comprises a telematics unit 1000, as shown in FIG. 1, which may be installed in a vehicle (not shown). As shown in FIG. 1, the unit 1000 (shown as T-Box 1000) has three parts: a central part 100, a 6 degrees of freedom inertial unit 200 and optional components 310-369. The central part 100 and the inertial unit 200 together form a key aspect of the telematics unit 1000 of the present embodiment.

Telematics unit 1000 is mounted within a vehicle by one or several possible mounting options. Telematics unit 1000 may be installed in an after-market process within the vehicle (meaning after the complete vehicle as such is fully assembled), or may be integrated into the vehicle during assembly. The telematics unit 1000 is connected to the vehicle DC power supply and can, but not need not, be connected to the vehicle controlling and processing system.

The central part 100 of the telematics unit 1000 includes global positioning system receiver 110, long distance wireless transceiver 120 and processing & controlling unit 130. Global positioning system receiver 110 receives satellite signals to calculate a position of the telematics unit 1000 using a satellite system such as GPS, Galileo, GLONASS, COMPASS, QZSS and may have specific accuracy enhancement functions. The overall position may be derived from a combination of information from different satellite location systems. The receiver system 110 may be realized within the telematics unit 1000 either by a module providing localization data (geographical coordinates) or by providing signals to the processing unit 130, which may calculate location data, besides other independent functions it undertakes. Global positioning receiver system 110 may be realized by a plurality of technologies and use an integrated antenna and/or an external antenna. This external antenna may be placed inside of the telematics unit 1000 enclosure (outside of the global positioning receiver system module 110) or outside of the telematics unit 1000 enclosure.

Long distance wireless transceiver 120 has the function of receiving and transmitting data (including raw data, and/or audio signals and/or video signals), with or without compression and with inherently imposed and optionally added additional encryption. Long distance wireless transceiver 120 typically uses cellular (mobile communication network) connectivity by one or a combination of systems:
a) Generation 2 (2G) mobile communication System (GSM, GPRS)
b) Generation 2.5 (2.5G) (EDGE)
c) Generation 3 (3G) (UMTS, WBCDMA, HDCPA)
d) Generation 4 (4G) (LTE)
   and/or systems like WiMax, and/or satellite communication systems, and/or other data transfer radio systems.

The global positioning receiver system 110 and the long distance wireless transceiver 120 may optionally be realized and utilized in the telematics unit 1000 as a single module.

Processing & controlling unit 130 is realized by any one of a plurality of known CPU solutions, whereby preferably a 32 bit processor optionally combined with DSP is preferred.

The CPU processor can use no or any operating system (OS), for example based on Linux, a Microsoft-based OS or another type of OS such as RTOS, VX Works and Android. An embedded Linux solution is preferred.

6 degrees of freedom inertial unit 200 is a 3D inertial sensor with 3D gyroscope functionality. It preferably comprises a 3D MEMS accelerometer 210 and a 3D MEMS gyroscope 220. 3D MEMS accelerometer 210 may be realized physically by using a single chip, more than one chip (typically one per direction per axis) or a module based on MEMS accelerator sensors. 3D MEMS gyroscope 220 may be realized physically by using a single chip, more than one chip or a module based on MEMS technology. The usage of devices realized by MEMS technology (Micro Electro-Mechanical Sensors) or NEMS (Nano Electro-Mechanical Sensors) enables the devices to be of small size and light-weight, and simplifies assembly of the proposed telematics unit 1000 PCB assembly. The 3D MEMS accelerometer 210 and 3D MEMS gyroscope 220 may be provided as a single chip or a single module.

Memory 310 may be realized using any suitable technology and can optionally be part of the memory of the processing and control unit 130. Preferably, the memory 310 comprises a non-volatile memory in which programming for the processing and controlling unit 130 and various coefficients are stored and a volatile memory, which may provide a working memory for the processing and controlling unit 130. The memory 310 provides resources for storing one or more of:
data before transmission over long range wireless transceiver 120
identification data of the vehicle
access, maintenance, and service data
business process relevant data
driving event data records related to the vehicle in which the telematics unit 1000 is mounted
event data profiles required to detect and react to a specific event
location based information with time stamps related to the vehicle
driver behaviour data associated with the specific pre-defined events with time stamps or statistically evaluated without time stamps
vehicle dynamic data (such as speed vectors and acceleration vectors) associated to the specific pre-defined events

Short range wireless connectivity 320 allows short range wireless data exchange between the telematics unit 1000 and a remote unit, for example where the remote unit is less than 500 metres, and typically less than 20 metres, away from the telematics unit 1000. It may be realized by any one of a plurality of well-known short range wireless solutions, such as one or more of:
Bluetooth Systems in the 2.4 GHz band
WLAN Systems in the 2.4 & 5 GHz band
ISM Band Systems in the 433 MHz, 866 MHz, 315 MHz, 915 MHz bands typically using protocols with limited duty cycles and typically 200 kbit/s max raw data rate in communication
UWB systems in the 3-10 GHz range
60 GHz-24 GHz communication systems
24 GHz communication systems
60-80 GHz Radar Systems
24 GHz Radar Systems

Short range wireless connectivity 320 allows:
wireless connectivity to an in-vehicle system; telematics unit may obtain internal information from the vehicle systems and use it for purposes such as event detection and related actions with dedicated time stamps
wireless connectivity for additional sensors such as wireless camera connection, or driving environment sensors
wireless connectivity to a driver's own independent personal information devices (PDA, Smart Phone or similar)
providing sensory activity by itself for purposes of distance calculations or object recognition, by deploying external connectors for additional antenna systems.

Connections to or the provision of sensor(s) 330 allows wired means of connection to a specific non inertial sensor, being placed in the telematics unit 1000 itself or outside of the telematics unit 1000, for example sensors for environmental factors.

Microphone 350 is used for audio capture.

Speaker 360 contains can be used to issue alerts from the telematics unit 1000 to the vehicle and the driver or to transmit alerts. A display (not shown) can also be used to provide the driver or another person with alerts and other information.

Wired interface to vehicle system and accessories 340 provides wired means for connection of the telematics unit 1000 to vehicle systems or accessories by at least one of the means:
Vehicle OBD Connector
CAN Interface
Lin Interface
FlexRay Interface
MOST Interface
SPI Interface
RS232 Interface
USB Interface

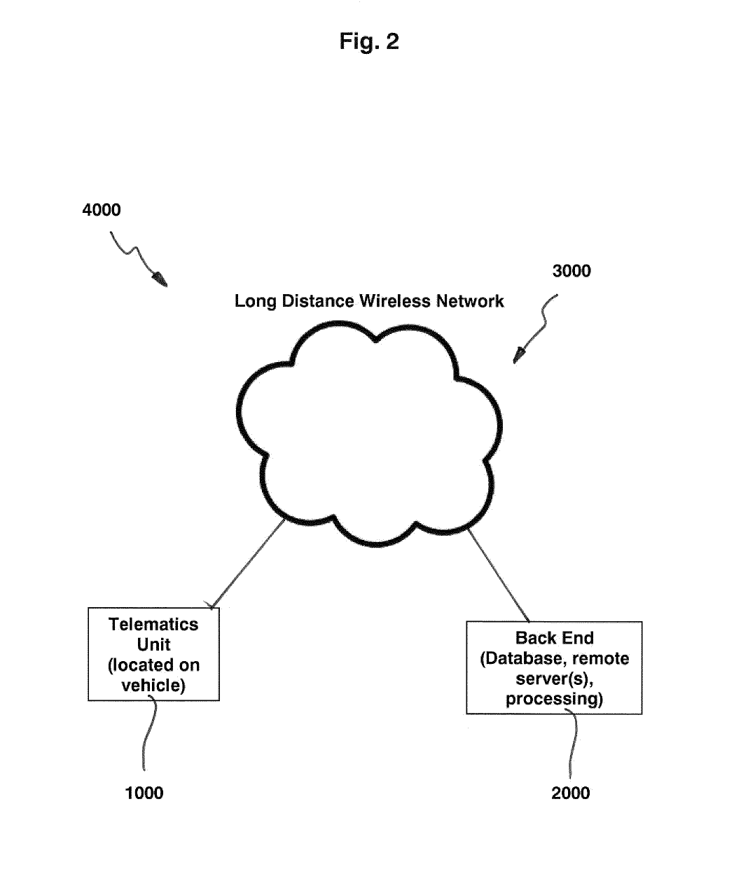

As shown in FIG. 2, the telematics unit 1000 can be connected to a remote processing entity 2000 or back end by means of a long distance wireless network 3000, typically a cellular or mobile phone network. These components together form a system 4000 of another embodiment of the invention, which will be discussed in more detail below.

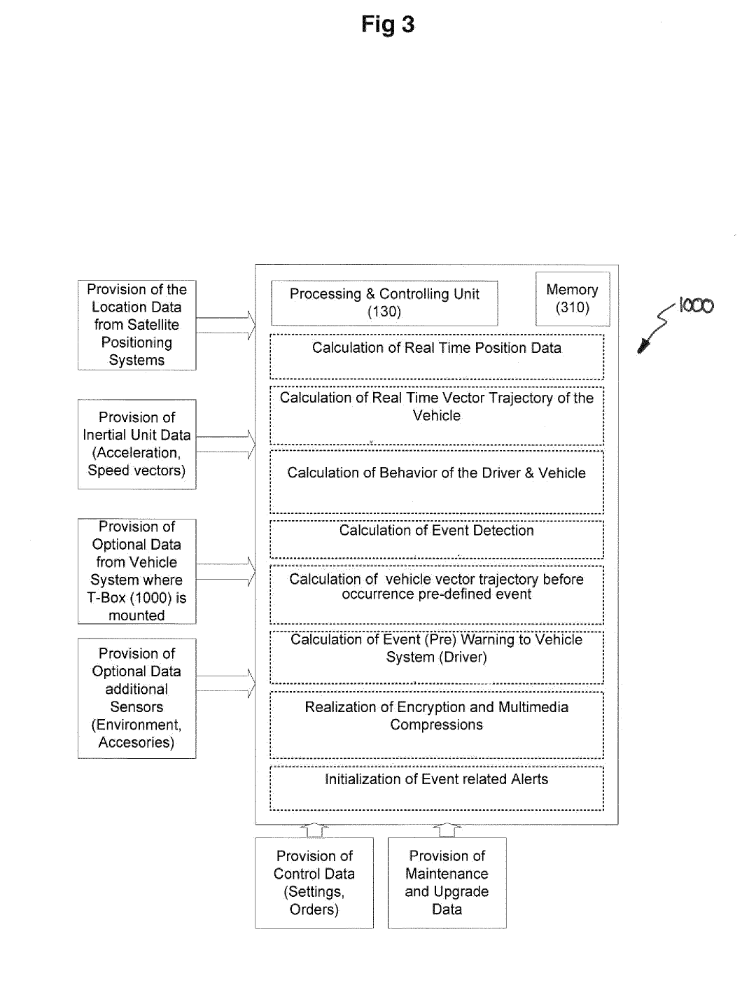

As schematically represented in FIG. 3, the telematics unit 1000 can receive a number of inputs and carry out a number of functions. In particular, the telematics unit 1000 may receive input data, provided to the processing and control unit 130 and the memory 310 in order to execute a variety of functions, including any one or more of:
location data from satellite positioning systems, typically provided by the global positioning receiver system 110
inertial unit data (such as acceleration and speed vectors) typically provided by the 3D inertial sensor with 3D gyroscope functionality 200
data from vehicle system where telematics unit 1000 is mounted, typically provided by the wired interface 340
data provided by the additional sensors (environment, accessories) 330
control data (settings, orders) typically provided by the back end 2000
maintenance and upgrade data typically provided by the back end 2000

Based on this received data, the processing and control unit 130 may carry out a number of functions, including any one or more of:
calculation of real time position data 11100
calculation of real time vector trajectory of the vehicle 11200
calculation of behaviour of the driver & vehicle 11300
calculation of event detection 11400
calculation of vector trajectory of the vehicle after event occurrence 11500
optional calculation of pre-event warning to vehicle system (driver) 11600
optional realization of encryption and multimedia compressions 11700
optional initialization of event related alerts 11800

Central to one aspect of the present invention are the detection of events 11400 that characterise risky and aggressive driving based on the inputs from the 3D inertial sensor with 3D gyroscope functionality and consequently the calculation of a driving behaviour risk indicator 11300, which will now be discussed in more detail.

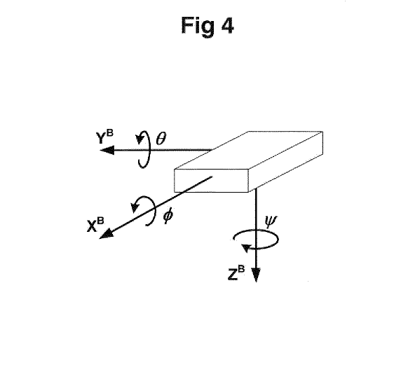

As shown in FIG. 4, the inertial sensor 200 is able to detect acceleration ‘a’ as vector having a magnitude in the direction of acceleration of the vehicle. In particular, the acceleration vector has a scalar component a_{X}, a_{Y}, a_{Z}, in each of three orthogonal axes (X, Y, Z), which are measured by the inertial sensor 200. In addition, the inertial sensor 200 is able to detect angular acceleration about each of the axes, where α_{ø}, α_{θ}, α_{ψ} are the angular accelerations about the X, Y, Z axes respectively. Thus, using the inertial sensor 200, the telematics unit 1000 is able to detect scalar acceleration information in predefined time periods as well as changes in the acceleration vector in the same periods. Moreover, given that the initial velocity will be known (zero before the vehicle moves), it is possible to calculate the velocity (both in terms of scalar velocity and velocity vector changes) and the roll, pitch and yaw rates, α_{ø}, α_{θ}, ω_{ψ} about the X, Y, Z axes respectively of the telematics unit 1000, and hence of the vehicle. Moreover, the use of the inertial unit 200 having six degrees of freedom allows determination of the real time vector trajectory of the vehicle, as well as the position of the vehicle (including its degree of roll, pitch and yaw) at any one time.

Accordingly, by determining the vector trajectory of the vehicle, the scalar velocity information, the scalar acceleration information, the velocity vector changes and the acceleration vector changes, it is possible to establish whether events that indicate unsafe or risky driving behaviour have taken place. Such events may include, by way of example, abrupt or harsh accelerations or decelerations, unsafe cornering for example by under-steering or over-steering, abrupt turning, spinning, rapid lane changes, skidding, barrier avoidance, excessive roll, pitch and/or yaw, unsafe speed variance, and speeding.

In the present embodiment, the processing and controlling unit 130 receives data from the inertial unit 200 and runs a plurality of algorithms in parallel to detect events in each of a predetermined number of categories, the number of such events in each category being counted and used to establish a driving behaviour risk indicator. Table 1 below is an example of algorithms that can be used by a telematics unit of the present invention.

TABLE 1

| Algorithm name | Description |
|---|---|
| Harsh Acceleration | Measures and classifies vehicle longitudinal |
| Monitoring | accelerations and deltaV (change of velocity |
| | in predefined period - typically 30 ms) in |
| | real time |
| Harsh Braking | Measures and classifies vehicle longitudinal |
| Monitoring | decelerations and deltaV in real time |
| Harsh Cornering | Measures and classifies vehicle lateral |
| Monitoring | accelerations in time periods at high speeds |
| Over-steering | Measures vehicle lateral accelerations in |
| Monitoring | time periods at high speeds and compares |
| | it with vehicle yaw rate at high speed. |
| | Algorithm output can be further classified |
| | by using different thresholds for detection |
| | of any one or more of vehicle skidding, |
| | abrupt turning and vehicle spinning events |
| Evasive Manoeuvre | Measures vehicle fast direction changes in |
| Monitoring | short time period (lateral accelerations) |
| | at high speeds. Algorithm output can be |
| | further classified by using different |
| | thresholds for detection of either or both |
| | abrupt lane change detection events and |
| | barrier avoidance events |
| Speed Variance | Measures speed variation in pre-defined time |
| Monitoring | periods (for example: 1 minute, 2 minutes). |
| | Significant speed variance is one of the |
| | specifics of aggressive driving. Speed |
| | variance algorithm detects and reports |
| | variation of speed above preset threshold |
| Speeding | Detects if vehicle speed exceeds predefined |
| Monitoring | speed limits during predefined time periods. |
| | Examples: vehicle driven above 90 km/h for |
| | 15 minutes, or above 160 km/h for 10 seconds |
| Driving Without a | Detects if vehicle is driven without break |
| Break Monitoring | of predefined length. Example - if vehicle |
| | is driven for more than 4 hours without |
| | minimum of 15 minute break |

The algorithms shown in Table 1 each monitor for one category of event. However, each category may include a number of sub-categories and, if desired, the respective algorithm can monitor for those sub-categories in addition to or instead of monitoring for the events in the main category. For example, the algorithm Over-Steering Monitoring monitors for harsh lateral movements of the vehicle. As sub-categories of such events, the algorithm may monitor for vehicle skidding, abrupt turning or vehicle spinning. Each sub-category can be detected by using effectively the same algorithm (as described in more detail below), but with different thresholds. Similarly, the algorithm Evasive Manoeuvre Monitoring collectively monitors for the sub-categories of abrupt lane change events and barrier avoidance events, where the driver may swerve sharply and potentially skid to avoid a crash barrier. Again, each sub-category can be detected by using effectively the same algorithm (as described in more detail below), but with different thresholds.

In addition, each category of event (or sub-category of event if these are monitored for) may be classified into ‘medium’ and ‘harsh’ events, where a harsh event indicates more aggressive or dangerous driving. Again, this can be achieved with the use of varying thresholds. The skilled addressee will appreciate that different and more levels of classification can be used.

In the detection of events “longitudinal acceleration” is defined as an acceleration component longitudinal to the direction of driving during a specified time increment. Thus, if the vehicle is driving along the X-axis shown in FIG. 4, and the Z-axis is vertical, the longitudinal acceleration will be defined as the acceleration in the X-axis. Similarly, “lateral acceleration” is defined as an acceleration component perpendicular to the direction of driving during a specified time increment. Similarly “Yaw rate” is calculated as the “angular rate” or angular speed (up) about the axis orthogonal to vehicle plane—in other words, the Z-axis if the vehicle is in the X-Y plane. “Vehicle velocity” is defined as the moving velocity of vehicle.

The telematics unit 1000 continually samples the inputs from the inertial unit 200 to detect events, for example so events can be detected each second or so. Sampling may be carried out, for example, at between 10 Hz and 100 Hz, although these sampling and event detection rates are not limiting on the invention.

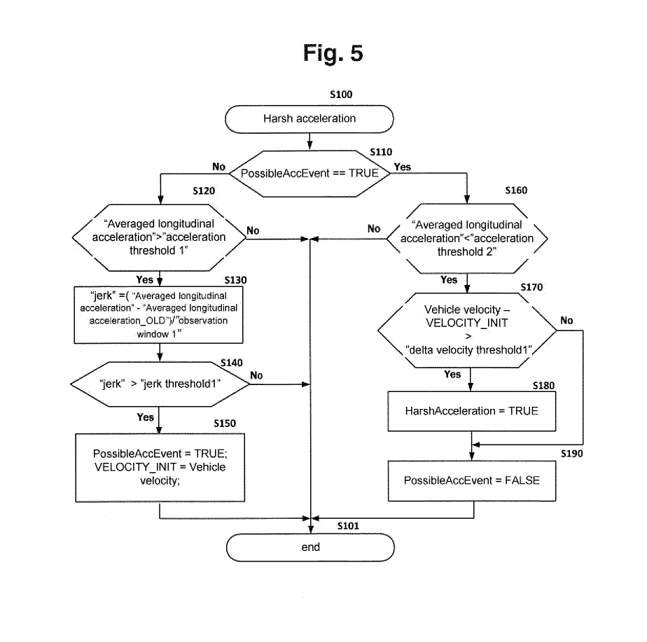

In more detail, the detection of a harsh acceleration event is shown in FIG. 5. First, a number of predetermined values will be retrieved from the memory 310. These are a value for an observation time window “observation window 1”, which will typically be set smaller than 1 second; a value for an acceleration threshold “acceleration threshold 1”, which will typically be set larger than 0.2 g, where g=9.81 ms⁻² (the value for “acceleration threshold 1” can also be set or adjusted based on a predefined profile depending on a current speed value or external data such as weather conditions or road type); a value for a jerk (derivative of acceleration) threshold “jerk threshold 1”, which will typically be set larger than 0.5 ms⁻³; a value for an acceleration threshold “acceleration threshold 2”, which will typically be set bellow 0.2 g (the value for “acceleration threshold 2” can also be set or adjusted based on a predefined profile depending on a current speed value or external data such as weather conditions or road type); and a value for a difference in velocity threshold “delta velocity threshold 1”, which will typically be set above 3 ms⁻¹ (the value for “delta velocity threshold 1” can also be set or adjusted based on a predefined profile depending on a current speed value or external data such as weather conditions or road type).

In detection of the event, “averaged longitudinal acceleration” is calculated as the “longitudinal acceleration” determined based on each of the samples from the inertial unit 200 averaged over the “observation window 1” time, in this case less than 1 s.

The “averaged longitudinal acceleration” will be stored in a circular buffer of a length matching “observation window 1” and an updated value is calculated for each sample, so several values for “averaged longitudinal acceleration” are stored in the circular buffer. For example, if the sampling rate is 10 Hz and the observation window is 1 second, a value for “averaged longitudinal acceleration” is calculated every 0.1 seconds based on the last 10 samples and 10 values for “averaged longitudinal acceleration” are stored in the buffer. “Averaged longitudinal acceleration OLD” is the oldest value from this circular buffer.

“Jerk” as a derivative of acceleration is calculated as the difference between “Averaged longitudinal acceleration” and “Averaged longitudinal acceleration OLD” divided by duration of “observation window 1”.

“PossibleAccEvent” is a Boolean variable or flag, and its initial state is FALSE.

The algorithm starts in step S100 by reading “averaged longitudinal acceleration” and “vehicle velocity”, and also updates the circular buffer that contains values of “averaged longitudinal acceleration”. Also for purpose of this algorithm the value stored in “averaged longitudinal acceleration OLD” variable is updated with the oldest sample from this buffer. The algorithm then proceeds according to its operation state denoted by Boolean variable “PossibleAccEvent”. In step S110, the algorithm determines whether “PossibleAccEvent” is TRUE.

If “PossibleAccEvent” is FALSE, meaning that the vehicle is not in a harsh accelerating manoeuvre, the algorithm checks if the first condition for harsh accelerating manoeuvre is satisfied in step S120 by determining if “averaged longitudinal acceleration” is larger than “acceleration threshold 1”. If this condition is met the algorithm proceeds to step S130. In step S130 the value of “jerk” is calculated as the difference between “averaged longitudinal acceleration” and “averaged longitudinal acceleration OLD” divided by the duration of “observation window 1”. After this, the process moves to S140 where it is checked whether “jerk” is larger than “jerk threshold1”. If this condition is met, meaning that a harsh acceleration manoeuvre may have started, the “PossibleAccEvent” flag is then set to TRUE in step S150, and the current value of “vehicle velocity” is stored in “VELOCITY_INIT” variable. Then the algorithm returns and waits for the next measurement at step S101. If the condition in step S120 is not met the algorithm returns and waits for next measurement at step S101 and no harsh acceleration event is detected. If the condition in step S140 is not met the algorithm returns and waits for the next measurement at step S101

If “PossibleAccEvent” in step S110 is TRUE, meaning that the vehicle may be in a harsh accelerating manoeuvre, the algorithm checks whether the harsh accelerating manoeuvre has finished by determining if “averaged longitudinal acceleration” is below “acceleration threshold 2” at step S160. If this condition is met the algorithm proceeds to step S170 where another condition is checked by determining if the difference between the current “vehicle velocity” and stored “VELOCITY_INIT” variable is larger than “delta velocity threshold 1”. If this condition is met, a harsh acceleration event is detected, and the algorithm proceeds to step S180 where harsh acceleration event specific data is stored to the memory 310. After this step the algorithm proceeds to step S190 where “PossibleAccEvent” is reset to FALSE. The algorithm then returns and waits for the next measurement at step S101. If the subtraction in step S170 is smaller than “delta velocity threshold 1” the algorithm jumps to step S190 meaning that no harsh acceleration event is detected. If the condition in step S160 is not met the algorithm returns and waits for the next measurement at step S101

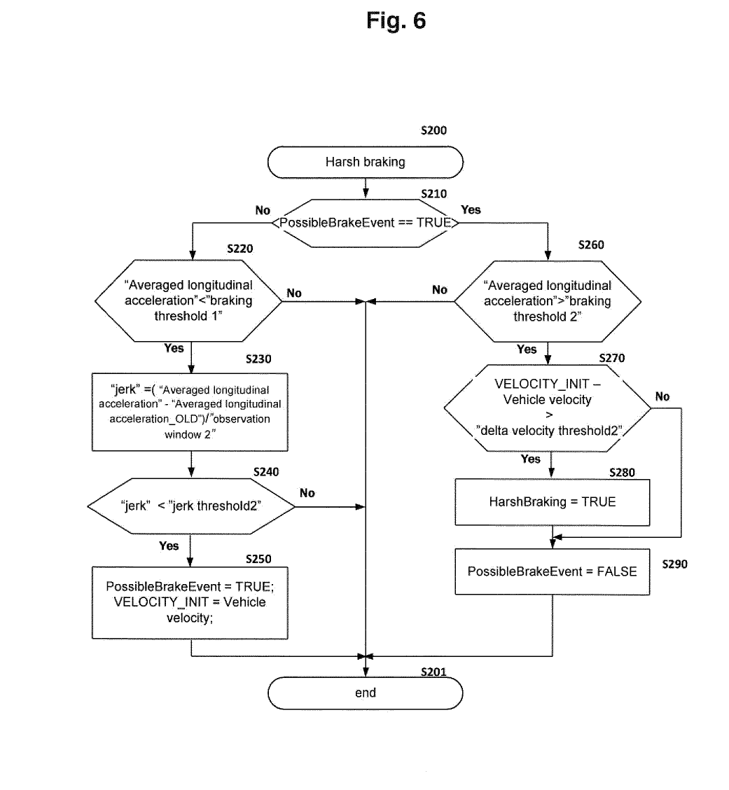

The detection of a harsh braking event is shown in FIG. 6. First, a number of predetermined values will be retrieved from the memory 310. These are a value for an observation time window “observation window 2”, which will typically be set smaller than 1 second; a value for an acceleration threshold “braking threshold 1”, which will typically be set larger than −0.4 g (negative), where g=9.81 ms⁻² (the value for “braking threshold 1” can also be set or adjusted based on a predefined profile depending on a current speed value or external data such as weather conditions or road type); a value for a jerk (derivative of acceleration) threshold “jerk threshold 2”, which will typically be set below −0.5 ms⁻³ (negative); a value for an acceleration threshold “braking threshold 2”, which will typically be set below −0.4 g (negative)(the value for “braking threshold 2” can also be set or adjusted based on a predefined profile depending on a current speed value or external data such as weather conditions or road type); and a value for a difference in velocity “delta velocity threshold 2”, which will typically be set above 3 ms⁻¹ (the value for “delta velocity threshold 2” can also be set or adjusted based on a predefined profile depending on a current speed value or external data such as weather conditions or road type).

In detection of the event, “averaged longitudinal acceleration” is calculated as the “longitudinal acceleration” averaged over the “observation window 2” time, in this case less than 1 s.

An “averaged longitudinal acceleration” will be stored in circular buffer of length matching “observation window 2”. “Averaged longitudinal acceleration OLD” is the oldest value from this circular buffer.

“Jerk” as derivative of acceleration is calculated as difference of “averaged longitudinal acceleration” and “averaged longitudinal acceleration OLD” divided by duration of “observation window 2”,

“PossibleBrakeEvent” is a Boolean variable or flag, and its initial state is FALSE.

The algorithm starts in step S200 by reading “averaged longitudinal acceleration” and “vehicle velocity”, and also updates the circular buffer that contains values of “averaged longitudinal acceleration”. Also for purpose of this algorithm the value stored in “averaged longitudinal acceleration OLD” variable is updated with the oldest sample from this buffer. The algorithm then proceeds according to its operation state denoted by Boolean variable “PossibleBrakeEvent”. In step S210, the algorithm determines whether “PossibleBrakeEvent” is TRUE.

If “PossibleBrakeEvent” is FALSE, meaning that the vehicle is not in a harsh braking manoeuvre, the algorithm checks if the first condition for a harsh braking manoeuvre is satisfied in step S220 by determining if “average longitudinal acceleration” is smaller than “braking threshold 2”. If this condition is met the algorithm proceeds to step S230. In step S230 the value of “jerk” is calculated as the difference between “averaged longitudinal acceleration” and “averaged longitudinal acceleration OLD” divided by the duration of “observation window 2”. After this, process moves to S240 where another condition is checked by determining if “jerk” is smaller than “jerk threshold 2”. If this condition is met, meaning that a harsh braking manoeuvre may have started, “PossibleBrakeEvent” is then set to TRUE in step S250 and the current value of “vehicle velocity” is stored in “VELOCITY_INIT” variable. Then the algorithm returns and waits for the next measurement at step S201. If the condition in step S220 is not met the algorithm returns and waits for the next measurement at step S201 and no Harsh braking event is detected. If the condition in step S240 is not met the algorithm returns and waits for the next measurement at step S201.

If “PossibleBrakeEvent” in step S210 is TRUE, meaning that the vehicle may be in a harsh accelerating manoeuvre, the algorithm checks whether the harsh accelerating manoeuvre has finished by determining if “averaged longitudinal acceleration” is above “braking threshold 2” at step S260. If this condition is met the algorithm proceeds to step S270 where another condition is checked by determining if the difference between stored “VELOCITY_INIT” variable and the current “vehicle velocity” is larger than “delta velocity threshold 2”. If this condition is met, a harsh deceleration or braking event is detected, and the algorithm proceeds to step S280 where harsh braking event specific data is stored to memory. After this step the algorithm proceeds to step S290 where “PossibleBrakeEvent” is reset to FALSE. The algorithm then returns and waits for the next measurement at step S201. If the subtraction in step S270 is smaller than “delta velocity threshold 2” the algorithm jumps to step S290 meaning that no harsh braking event is detected. If the condition in step S260 is not met the algorithm returns and waits for the next measurement at step S201

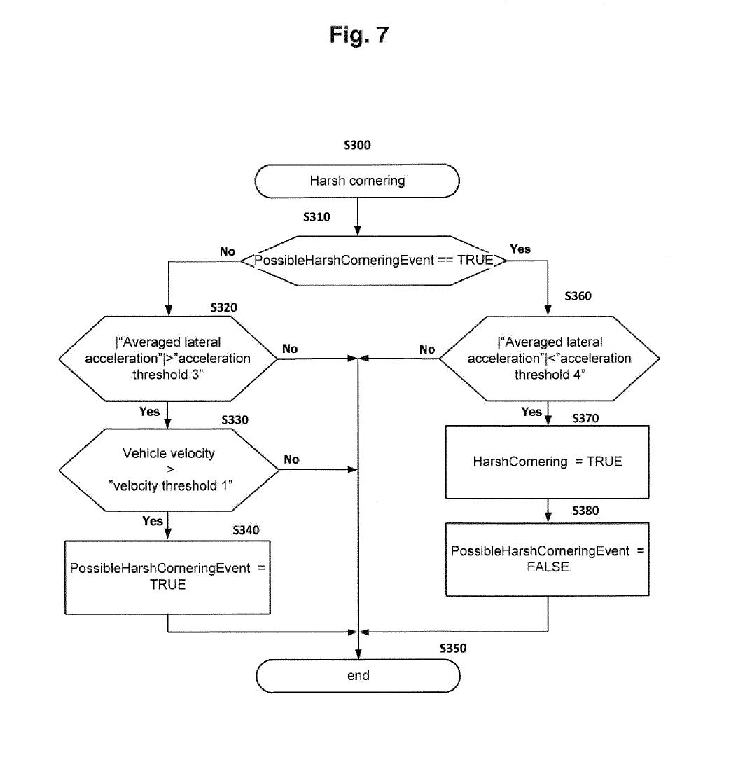

The detection of a harsh cornering event is shown in FIG. 7. First, a number of predetermined values will be retrieved from the memory (not shown). These are a value for an observation time window “observation window 3”, which will typically be set smaller than 0.5 seconds; a value for an acceleration threshold “acceleration threshold 3”, which will typically be set larger than 0.4 g, where g=9.81 ms⁻² (the value for “acceleration threshold 3” can also be set or adjusted based on a predefined profile depending on the current speed value); a value for a velocity threshold “velocity threshold 1”, which will typically be set larger than 6 ms⁻¹; and a value for an acceleration threshold “acceleration threshold 4”, which will typically be set bellow 0.4 g (the value for “acceleration threshold 4” can also be set or adjusted based on a predefined profile depending on current speed value).

In detection of the event, “averaged lateral acceleration” is calculated as the “lateral acceleration” averaged over the “observation window 3” time, in this case less than 0.5 seconds.

“PossibleHarshCorneringEvent” is a Boolean variable or flag, and its initial state is FALSE.

The algorithm starts in step S300 by reading “averaged lateral acceleration” and “vehicle velocity”. The algorithm then proceeds according to its operation state denoted by Boolean variable “PossibleHarshCorneringEvent” which is initialized to FALSE. In step S310, the algorithm determines whether “PossibleHarshCorneringEvent” is TRUE.

If “PossibleHarshCorneringEvent” is FALSE, meaning that the vehicle is not in a harsh cornering manoeuvre, the algorithm checks if the first condition for a harsh cornering manoeuvre is satisfied in step S320 by determining if “averaged lateral acceleration” is larger than “acceleration threshold 3”. If this condition is met the algorithm proceeds to step S330, where the second condition is checked by determining if “vehicle velocity” is larger than “velocity threshold 1”. If this condition is met, meaning that a harsh cornering manoeuvre may have started, “PossibleHarshCorneringEvent” is set to TRUE in step S340, and then the algorithm returns and waits for the next measurement at step S350. If the condition in step S320 is not met the algorithm returns and waits for the next measurement at step S350. If the condition in step S330 is not met the algorithm returns and waits for the next measurement at step S350.

If “PossibleHarshCorneringEvent” is TRUE, meaning that the vehicle may be in a harsh cornering manoeuvre, the algorithm checks if the harsh cornering manoeuvre has finished by determining if “averaged lateral acceleration” is below “acceleration threshold 4” at step S360. If this condition is met the algorithm proceeds to step S370 where harsh cornering event specific data is stored in memory, and the algorithm proceeds to step S380 where “PossibleHarshCorneringEvent” is set to FALSE. After this step the algorithm returns and waits for the next measurement at step S350. If the condition in step S360 is not met the algorithm returns and waits for the next measurement at step S350.

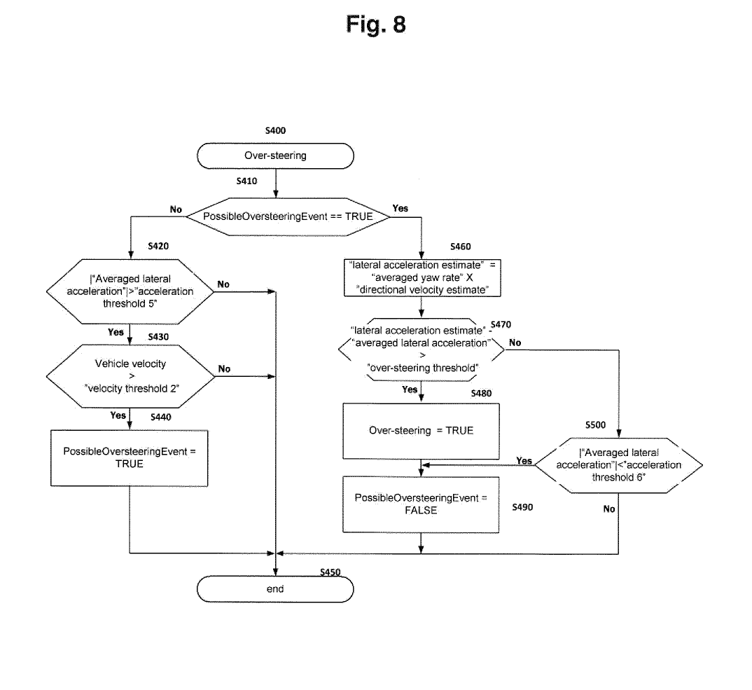

The detection of an over-steering event is shown in FIG. 8. First, a number of predetermined values will be retrieved from the memory (not shown). These are a value for an observation time window “observation window 4”, which will typically be set smaller than 0.5 second; a value for an acceleration threshold “acceleration threshold 5”, which will typically be set larger than 0.6 g, where g=9.81 ms⁻² (the value for “acceleration threshold 5” can also be set or adjusted based on a predefined profile depending on the current speed value); a value for a velocity threshold “velocity threshold 2”, which will typically be set larger than 6 ms⁻¹; a value for an acceleration difference threshold “over-steering threshold”, which will typically be larger than 0.2 g (the value for the “over-steering threshold” can also be set or adjusted based on a predefined profile depending on the current speed value); and a value for an acceleration threshold “acceleration threshold 6”, which will typically be set bellow 0.4 g (the value for the “acceleration threshold 6” can also be set or adjusted based on a predefined profile depending on current speed value).

In detection of the event, “averaged lateral acceleration” is calculated as the “lateral acceleration” averaged over the “observation window 4” time, in this case less than 0.5 seconds.

“Averaged yaw rate” is calculated as “yaw rate” averaged over the “observation window 4” time, in this case less than 0.5 seconds.

“Directional velocity estimate” is defined as the velocity component (that is, the magnitude of the velocity vector) in the moving direction estimated at inertial sensor sampling rate (which is higher than the odometer or GNSS velocity update rate, if such external sensor data is used). Thus, if the vehicle travels in the longitudinal direction, the directional velocity estimate is the velocity of the vehicle in the longitudinal direction calculated based on inputs from the sensors obtained at the sensor sampling rate.

“Lateral acceleration estimate” is calculated by multiplying “averaged yaw rate” and “directional velocity estimate”.

“PossibleOversteeringEvent” is a Boolean variable or flag, and its initial state is FALSE.

The algorithm starts in step S400 by reading “averaged lateral acceleration”, “averaged yaw rate” and “vehicle velocity”. The algorithm then proceeds according to its operation state denoted by Boolean variable “PossibleOversteeringEvent” which is initialized to FALSE. In step S410, the algorithm determines whether “PossibleOversteeringEvent” is TRUE.

If “PossibleOversteeringEvent” is FALSE, meaning that the vehicle is not in an over-steering manoeuvre, the algorithm checks if the first condition for the over-steering manoeuvre is satisfied in step S420 by determining if “average lateral acceleration” is larger than “acceleration threshold 5”. If this condition is met the algorithm proceeds to step S430, where the second condition is checked by determining if “vehicle velocity” is larger than “velocity threshold 2”. If this condition is met, meaning that an over-steering manoeuvre may have started, “PossibleOversteeringEvent” is set to TRUE in step S440, and then the algorithm returns and waits for the next measurement at step S450. If the condition in step S420 is not met the algorithm returns and waits for the next measurement at step S450. If the condition in step S430 is not met the algorithm returns and waits for the next measurement at step S450.

If “PossibleOversteeringEvent” is TRUE, meaning that an over-steering manoeuvre may have started, the algorithm calculates “lateral acceleration estimate” at step S460, and moves to step S470 in which the absolute difference between “lateral acceleration estimate” and “average lateral acceleration” is compared to “over-steering threshold”. If the difference is larger than “over-steering threshold” an over-steering event is detected in step S480 and over-steering event specific data is stored in memory. After this step the algorithm proceeds to step S490 where “PossibleOversteeringEvent” is set to FALSE, the algorithm returns and waits for the next measurement at step S450. If the difference is smaller than “over-steering threshold” in step S470 the algorithm proceeds to step S500 where it is determined if “average lateral acceleration” is below “acceleration threshold 6”, meaning that there is no over-steering event detected and the algorithm moves to step S490. Else if “average lateral acceleration” is larger than “acceleration threshold 6” in step S500 there is still a possibility to detect an over-steering event and the algorithm returns and waits for the next measurement at step S450.

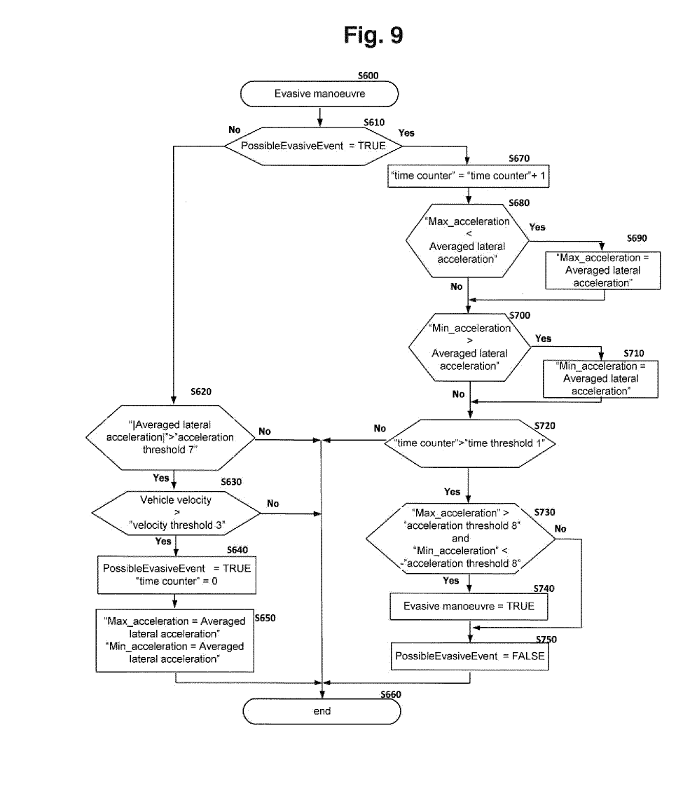

The detection of an evasive manoeuvre is shown in FIG. 9. First, a number of predetermined values will be retrieved from the memory (not shown). These are a value for an observation time window “observation window 5”, which will typically be set smaller than 0.5 seconds; a value for an acceleration threshold “acceleration threshold 7”, which will typically be set larger than 0.2 g, where g=9.81 ms⁻² (the value for “acceleration threshold 7” can also be set or adjusted based on predefined profile depending on the current speed value); a value for a velocity threshold “velocity threshold 3”, which will typically be set larger than 6 ms⁻¹; a value for a time threshold “time threshold 1”, which will typically be set smaller than 4 seconds (the value for “time threshold 1” can also be set or adjusted based on a predefined profile depending on the current speed value); and a value for an acceleration threshold “acceleration threshold 8”, which will typically be set larger than 0.3 g (the value for “acceleration threshold 8” can also be set or adjusted based on a predefined profile depending on the current speed value).

In detection of the event, “Averaged lateral acceleration” is calculated as the “lateral acceleration” averaged over the “observation window 5” time, in this case less than 0.5 seconds.

“PossibleEvasiveEvent” is a Boolean variable or flag, and its initial state is FALSE.

“Max_acceleration” is a variable used to store max acceleration in an evasive manoeuvre.

“Min_acceleration” is a variable used to store min acceleration in an evasive manoeuvre.

“Time counter” is a variable used to count samples and measure time.

The algorithm starts in step S600 by reading “averaged lateral acceleration”, and “vehicle velocity”. The algorithm then proceeds according to its operation state denoted by Boolean variable “PossibleEvasiveEvent” which is initialized to FALSE.

In step S610, the algorithm determines whether “PossibleEvasiveEvent” is TRUE. If “PossibleEvasiveEvent” is FALSE, meaning that the vehicle is not in an evasive manoeuvre, the algorithm checks if the first condition for an evasive manoeuvre is satisfied in step S620 by determining if “average lateral acceleration” is larger than “acceleration threshold 7”. If this condition is met the algorithm proceeds to step S630, where the second condition is checked by determining if “vehicle velocity” is larger than “vehicle velocity 2”. If this condition is met, meaning that it is possible to detect evasive manoeuvre (in other words, and evasive manoeuvre may be taking place), “PossibleEvasiveEvent” is set to TRUE and “time counter” is set to zero in step S640, followed by setting both “Max_acceleration” and “Min_acceleration” to the current value of “averaged lateral acceleration” in step S650. Then the algorithm returns and waits for the next measurement at step S660. If the conditions in either step S620 or step S630 is not met, the algorithm returns and waits for the next measurement at step S660.

If “PossibleEvasiveEvent” is TRUE, meaning that an evasive manoeuvre may have started, the algorithm moves to step S670 where “time counter” is incremented. This is followed by step S680 in which it is determined if variable “Max_acceleration” is smaller than “averaged lateral acceleration”, and if so the algorithm moves to step S690 where the current value of “averaged lateral acceleration” is assigned to “Max_acceleration” and the algorithm proceeds to step S700. If the condition in S680 is not met the algorithm proceeds directly to step S700. In step S700 it is determined if variable “Min_acceleration” is larger than “averaged lateral acceleration”, and if so the algorithm moves to step S710 where the current value of “averaged lateral acceleration” is assigned to “Min_acceleration” and the algorithm proceeds to step S720. If the condition in S700 is not met the algorithm proceeds directly to step S720. In step S720 it is checked if “time counter” is larger than “time threshold 1”, and if so the algorithm proceeds to step S730, else the algorithm returns and waits for the next measurement at step S660. In step S730 it is determined if two conditions are met, namely if “Max_acceleration” is larger than “acceleration threshold 8” and if “Min_acceleration” is smaller than—“acceleration threshold 8”. If both conditions are met, meaning that an evasive manoeuvre is detected, the algorithm proceeds to S740 where all specific data for an evasive manoeuvre event are stored in memory. After step S740 the algorithm proceeds to step S750 where “PossibleEvasiveEvent” is set to FALSE, and the algorithm returns and waits for the next measurement at step S660. If one or both of the conditions in step S730 are not met, the algorithm proceeds directly to step S750.

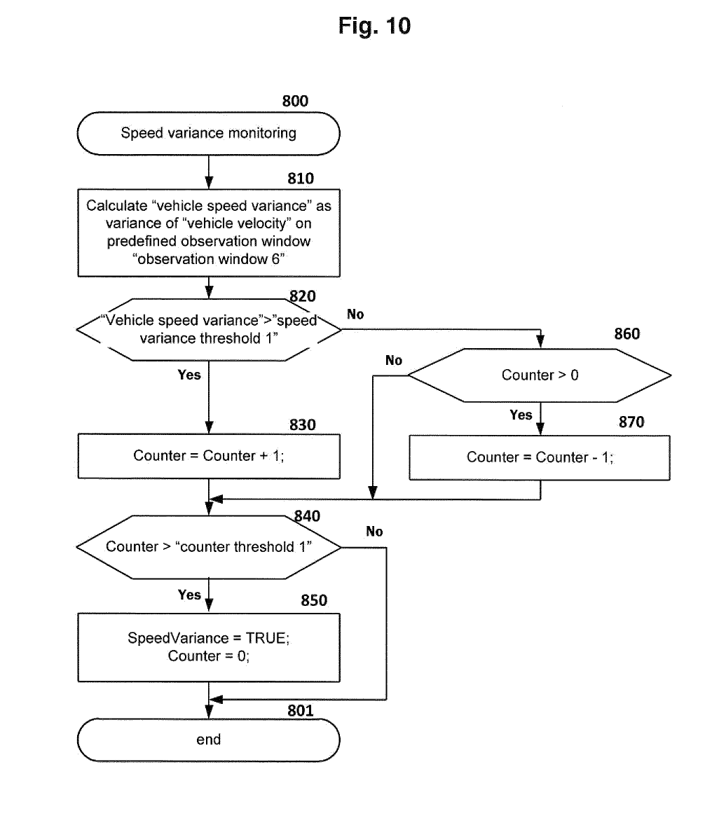

The detection of a speed variance event is shown in FIG. 10. First, a number of predetermined values will be retrieved from the memory (not shown). These are a value for an observation time window “observation window 6”, which will typically be set larger than 30 seconds; a value for a speed variance threshold “speed variance threshold 1”, which will typically be set larger than 1 (the value for “speed variance threshold 1” can also be set or adjusted based on a predefined profile depending on the current speed value or external data such as weather conditions, road type and traffic conditions); and a value for a time duration threshold “counter threshold 1”, which will typically be set larger than 10.

“Counter” is a variable used to count samples and measure, and its initial state is 0.

“Vehicle velocity” will be stored in a circular buffer of length matching “observation window 6” and continually updated with each sample.

In detection of the event, “vehicle speed variance” is calculated as the variance of “vehicle velocity” over predefined “observation window 6”, in this case larger than 30 seconds. There are various standard ways to calculate variance, including absolute deviation, squared deviation, standard deviation etc and any suitable measure of variance may be used. For example, “vehicle speed variance” may be determined simply as the difference between the maximum and minimum values for “vehicle velocity” held in the buffer at the current time. The result of maximum-minimum calculation would not strictly speaking be variance directly, but rather+/−3 sigma interval where variance could be extracted as sigma².

The algorithm starts in step S800 by reading “vehicle velocity” and also updates the circular buffer that contains historical values of “vehicle velocity” over length of “observation window 6”. The algorithm then proceeds to step S810, where “vehicle speed variance” is calculated as variance of “vehicle velocity” over the predefined observation window “observation window 6” by using data from the circular buffer.

After this, the process moves to S820 where it is determined if “vehicle speed variance” is greater than “speed variance threshold 1”. If this condition is met the algorithm proceeds to step S830. In step S830 the value of “Counter” is incremented by one. After this, the process moves to S840 where another condition is checked by determining if the value of “Counter” is greater than “counter threshold 1”. If this condition is met, a speed variance event is detected, and the algorithm proceeds to step S850 where speed variance event specific data is stored to memory 310 and “Counter” is reset to zero. The algorithm then returns and waits for the next measurement at step S801.

If the condition in step S820 is not met the algorithm proceeds to step S860 where another condition is checked by determining if the value of “Counter” is greater than zero and if so, the process moves to step S870. In step S870 the value of “Counter” is decremented by 1 and then the process continues to S840. If the condition from step S860 is not met, the process continues to S840.

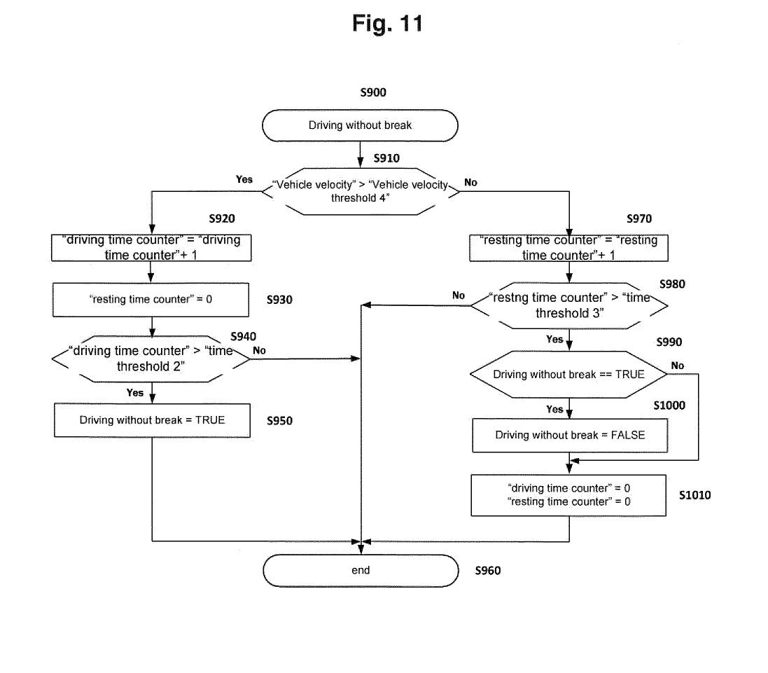

In more detail, the detection of a driving without break event is shown in FIG. 11. First, a number of predetermined values will be retrieved from the memory (not shown). These are a value for a velocity threshold “velocity threshold 4”, which will typically be set larger than 0 ms⁻¹; a value for time threshold “time threshold 2”, which will typically be set larger than 4 hours (the value for “time threshold 2” can also be set or adjusted based on a predefined profile depending on external data such as weather conditions, road type and traffic conditions); and a value for time threshold “time threshold 3”, which will typically be set larger than 15 minutes (the value for “time threshold 3” can also be set or adjusted based on a predefined profile depending on external data such as weather conditions, road type and traffic conditions).

In detection of the event, “Driving time counter” is a variable used to measure driving time without a break.

“Resting time counter” is a variable used to measure resting time.

“Driving without break” is a Boolean variable or flag used to indicate that driver has driven for too long without resting. The initial value of this variable is FALSE.

The algorithm starts in step S900 by reading “vehicle velocity”. The algorithm then proceeds according to its operation state denoted by condition S910 where is determined if “vehicle velocity” is larger than “vehicle velocity threshold 4”.

If the condition in S910 is met, meaning that the vehicle is driving, the algorithm proceeds to step S920 where “driving time counter” is incremented, and step S930 where “resting time counter” is set to zero. This step is followed by step S940 where it is checked if “driving time counter” is larger than “time threshold 2”. If this condition is met, meaning that driver has driven the vehicle for a long time without resting, the algorithm proceeds to step S950 where “Driving without break” is set to TRUE and the algorithm returns and waits for the next measurement at step S960. If condition in S940 is not met the algorithm returns and waits for the next measurement at step S960.

If condition in S910 is not met, meaning that the vehicle is steady, the algorithm proceeds to step S970 where “resting time counter” is incremented. This step is followed by step S980 where it is determined if “resting time counter” is larger than “time threshold 3”. If this condition is met, meaning that driver has rested for enough time, the algorithm proceeds to step S990. In step S990 is determined if “Driving without break” is TRUE. If this condition is met, meaning that driver has driven for too long before resting, the algorithm proceeds to step S1000 where event specific data is stored in memory. After step S1000 both variables “driving time counter” and “resting time counter” are set to zero in step S1010. Then the algorithm returns and waits for the next measurement at step S960.

If condition in S990 is not met, meaning that the driver has rested enough to continue driving, the algorithm proceeds to step S1010 where both variables “driving time counter” and “resting time counter” are set to zero. After this step the algorithm returns and waits for the next measurement at step S960.

Events are detected in the manner described above as the vehicle is driven. Each event may be associated with a time stamp indicating the time at which the event was detected and/or with an indication of the driver. In the present invention, the detection of individual events in each category is used to determine a driving behaviour risk indicator. In particular, the control and processing unit 130 keeps a count of the number of events in each category. In addition, a weighting factor or risk multiplier is stored, preferably in a look up table, in the memory 310 for each category of event.

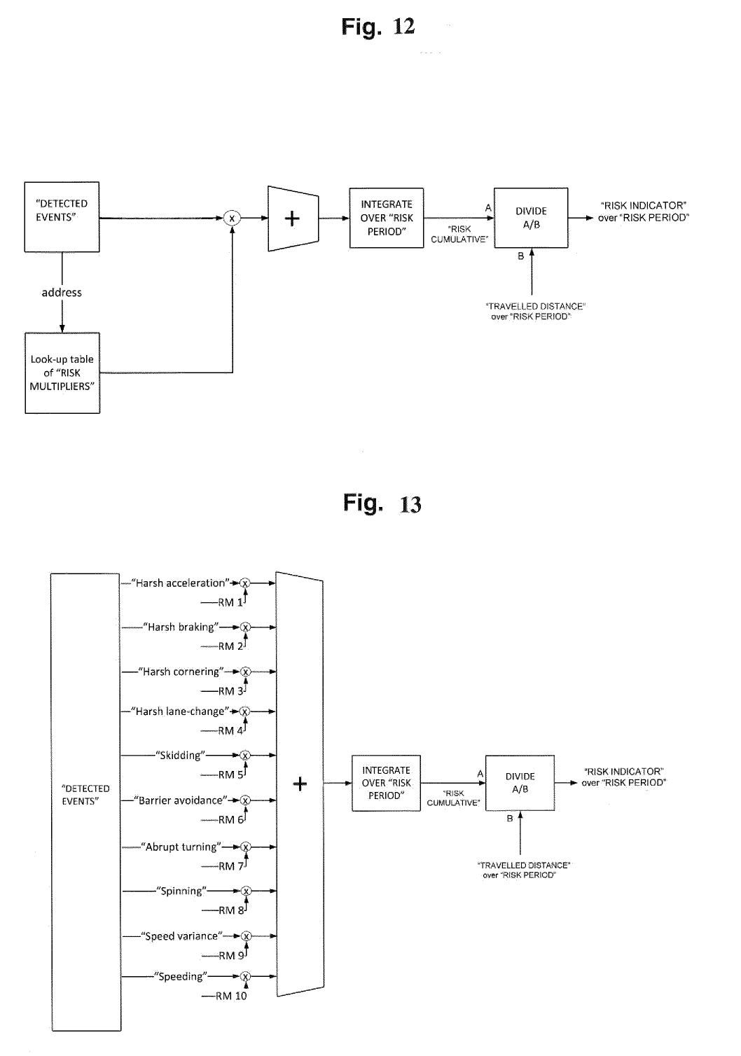

As shown in FIG. 12, to calculate the driving behaviour risk indicator, a specific observation time or “Risk Period” is set. This could be, for example, one day or one month, although any suitable period may be chosen. The period could be the most recent period (for example, the last 24 hours or the last month) or a period selected arbitrarily from the past (for example, 1^{st} June or the whole of September). The control and processing unit 130 retrieves from the memory all the events that occurred in the selected risk period, together with the risk multipliers from look up table, and multiplies the number of events in each category with the respective risk multiplier. The control and processing unit 130 then sums the results of these multiplications to determine a cumulative risk for the risk period.

It will be apparent to those skilled in the art that some events indicate more dangerous or risky behaviour than others. For example, harsh acceleration and braking are less risky than harsh cornering and lane changes, which are in turn less risky than skidding, spinning and barrier avoidance, for example. The use of the risk multipliers is intended to reflect this, so the risk multiplier for harsh acceleration will be lower than that for spinning, for example. Each of the parameters used in determining the respective events, which events are determined and the risk multipliers can all be adjusted to fine tune the driving behaviour risk indicator, and if to place greater importance on risk-indicative events of interest and to place less or no importance on other events. Thus, if the value of the risk multiplier for a category of event is 0, events in that category will not count towards determination of the driving behaviour risk indicator. Conversely, the higher the value of a risk multiplier relative to other risk multipliers, the greater effect events in the corresponding category will have on the driving behaviour risk indicator.

For example, if the control and processing unit 130 is adapted to monitor for harsh acceleration events, harsh cornering events, skidding events and abrupt turning events, then suitable weighting factors (risk multipliers) might be 1 for harsh acceleration events, between 1 and 5 for harsh cornering events, between 2 and 10 for skidding events and between 10 and 50 for abrupt turning events. A range of values has been given here and it will be within the compass of the skilled addressee to set the respective risk multipliers to a value within the range (or even outside the range) for each category of event. Moreover, if events are classified as ‘medium’, ‘harsh’ etc, different risk multipliers can be set for the different classifications of event. The skilled addressee will recognise that these risk multipliers are indicative only and that any suitable risk multipliers can be chosen.

The cumulative risk calculated in this way may be used as the risk indicator without further adjustment. However, in preferred embodiments of the invention, the cumulative risk is integrated over the duration of the risk period or divided by the duration of the risk period. Optionally, this can be used as the risk indicator without further adjustment.

However, it is further preferred that a measure of the distance travelled during the risk period is also recorded and stored by the telematics box 1000. The final driving behaviour risk indicator is then obtained by dividing the integrated cumulative risk (or cumulative risk per unit of time) by the measure of the distance travelled in the risk period. If the cumulative risk is not integrated over or divided by the duration of the risk period, the unadjusted cumulative risk may be divided by the measure of distance driven to obtain the final driving behaviour risk indicator.

FIG. 13 shows a specific embodiment, in which the detected events are harsh acceleration, harsh braking, harsh cornering, harsh lane change, skidding, barrier avoidance, abrupt turning, spinning, speed variance and speeding.

It will be apparent that all the inputs required by the processing and control unit 130 to determine the driving behaviour risk indicator can be obtained from the inertial unit 200 in combination with a clock (not shown), which is preferably provided as part of the processing and control unit 130. In particular, the processing and control unit 130 is able to determine distance travelled, linear velocity, angular rate, linear acceleration and angular acceleration based on inputs from the inertial unit 200, and hence to determine the occurrence of each of the risk-indicative events discussed above. In particular, by use of the inertial unit 200 having six degrees of freedom, it is possible to accurately monitor for a significant number of higher-risk events, for example by monitoring cornering, lane change, skidding, over- and under-steering, barrier avoidance, abrupt turning and spinning that could not previously be included in risk assessment, together with lower-risk “linear” events, for example by speed, speed variance, acceleration and braking monitoring.

As previously noted, in Table 1 above the six degrees of freedom inertial unit 200 is used to monitor for harsh lateral events (which may include monitoring for harsh cornering, over-steering (skidding), abrupt turning and vehicle spinning cumulatively and/or separately depending on the number and values of the thresholds selected; and for barrier avoidance events (which may include monitoring for abrupt lane changes and barrier avoidances cumulatively and/or separately depending on the number and values of the thresholds selected).

Moreover, in order to carry out the driving behaviour risk indicator calculation, the telematics elements of the telematics unit 1000 are not required in the present invention and can therefore be removed if desired. In particular, only the inertial sensor 200, the processing and control unit 130 and the memory 310 are essential and any two or more of these can be integrated.

Alternatively, the unit 1000 can make use of other inputs to improve or otherwise adjust calculation of the driving behaviour risk indicator. For example, the unit 1000 may make use of global positioning receiver system to place the vehicle on a pre-stored map or a map downloaded from the remote processing entity 2000 or another source via the long distance wireless transceiver 120, the short range wireless connectivity 320 or the wired interface 340. This can be used to compare or correct the vehicle trajectory or speed, and map information, such as the speed limit for the section of road on which the vehicle is driving, can be used to feed into event detection. For example, the speed monitoring algorithm can compare the vehicle speed with a threshold based on the speed limit derived from map data for a section of road on which the vehicle is travelling and determine the occurrence of events on this basis. Global positioning data can also be used to correct or provide distance travelled by the vehicle. In addition, global positioning systems can be used by the back end 2000 to monitor the distance travelled by the vehicle, which can then be sent to the vehicle over the long distance wireless network.

Although the telematics unit 1000 has been described detecting individual events and the driving behaviour risk indicator, instead it may send either the data needed to determine whether an event has occurred or the count of events in each category to the back end 2000, which then carries out event detection and/or driving behaviour risk indicator calculation for the individual vehicle. The event count and/or driving behaviour risk indicator may be sent back to the telematics unit 1000, or another device, whether or not on the vehicle.

Preferably the back end 2000 comprises a server and/or processing entity or a plurality of these and provides a web interface or other interfaces to allow remote users to generate and/or gain access to driving behaviour risk indicators either via the web or via other devices such as smart phones, PDAs and the like.

The connection to or provision of sensors 330 may allow the input of environmental conditions such as temperature (for detection of the likelihood of ice on the roads), rain, snow, strong winds and so forth. As with the global positioning data, the input from the sensors can be used to modify the thresholds used in event detection and/or the risk multipliers. Alternatively, the driving behaviour risk indicator calculated in the normal way can be modified based on the environmental conditions. For example, if a driver is driving with risk-indicative events in strong winds, snow, ice and rain, this may indicate higher risk than at other times and this is factored into the driving behaviour risk indicator in one of the ways just discussed, or any other suitable way. If both events and data indicating environmental conditions are time-stamped, then the events can be matched to the prevailing environmental conditions to further refine a driving behaviour risk indicator. In this way it becomes possible to establish how individuals, vehicles and fleets manage their risk in different weather and other environmental conditions. Other possible inputs include vehicle inputs such as brake and accelerator pedal angles, odometer, and engine running and on-board diagnostic data.

It will be appreciated that so far the calculation of a driving behaviour risk indicator has been described based on a single telematics unit 1000 in a single vehicle and the driving behaviour risk indicator calculated for the unit 1000 or vehicle as a whole. However, a vehicle may be driven by different people and it is desirable to provide driving behaviour risk indicators for individuals as well as vehicles. This can be achieved either by setting the risk period to a first period where it is known a particular driver was driving the vehicle to calculate a first driving behaviour risk indicator and calculating a second driving behaviour risk indicator for another driver by setting the risk period to a second period where it is known the other driver was driving the vehicle.

Alternatively, individual drivers may be identified by using separate ignition keys or other identifiers required to operate the vehicle. Separate event calculation, distance travelled and driving behaviour risk indicators can then automatically be produced for each driver.

In a further embodiment, the present invention can be used to determine driving behaviour risk indicators for vehicles and/or drivers in a fleet of vehicles, as well as for individual vehicles.

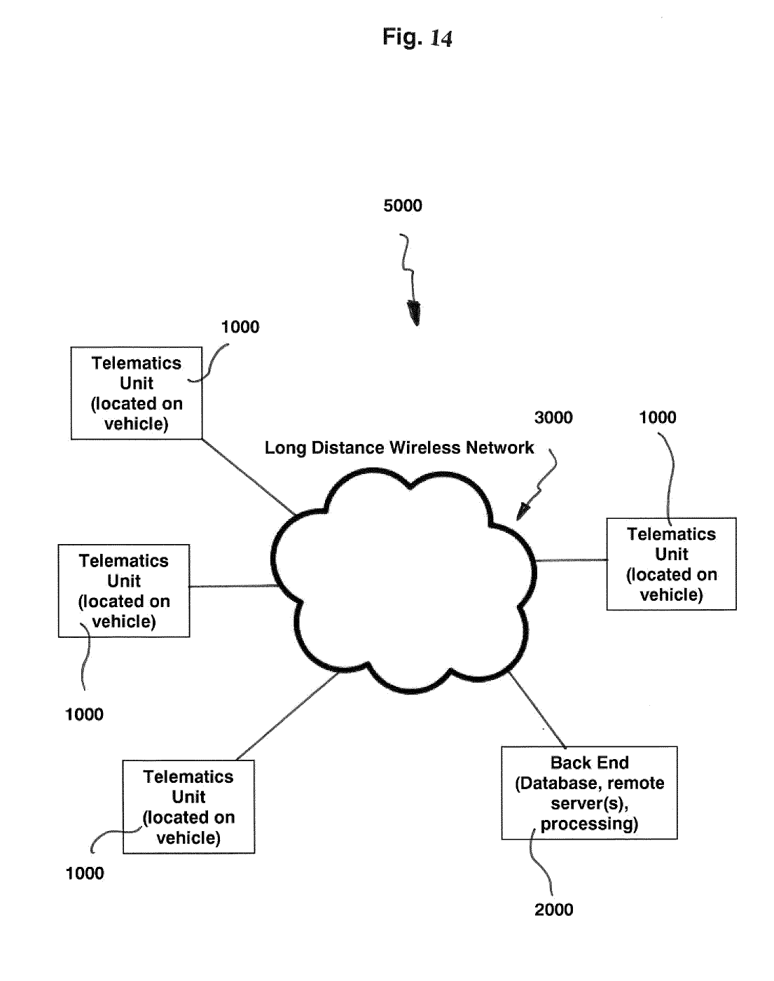

Thus, FIG. 14 shows a system 5000 according to the present invention comprising a back end 2000 and a plurality of telematics boxes 1000 each in communication with the back end 2000 via the long distance wireless network 3000. In the preferred embodiment, the control and processing units 130 calculate the events in each category and store the counts in the memory 310. Each processing unit 130 then sends the counts to the back end processing unit 2000 at predetermined times, with a predetermined frequency, or on request from the back end 2000. The events are preferably sent back with a time stamp indicating the time they occurred and may also be sent back with an indication of the telematics unit 1000 they came from and/or an indication of the driver at the time the event occurred. Alternatively, if the events are sent to the back end 2000 at a regular frequency, or it is not desired to calculate the driving behaviour risk indicator for particular risk periods and/or particular vehicles and/or drivers, the time stamp/indication of vehicle/indication of driver may not be necessary.

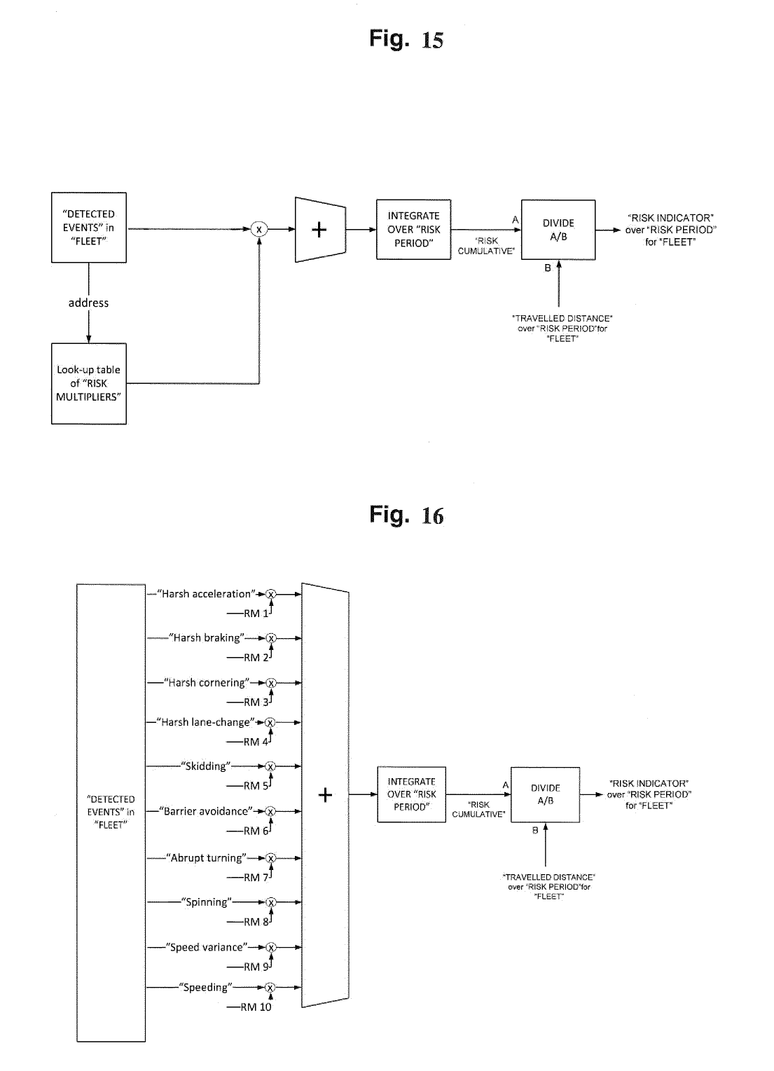

As shown in FIG. 15, the back end 2000 then sums all the events in each category and applies the risk multipliers to the number of events in the respective categories. FIG. 16 shows a specific embodiment, in which the detected events are harsh acceleration, harsh braking, harsh cornering, harsh lane change, skidding, barrier avoidance, abrupt turning, spinning, speed variance and speeding.

If the other inputs to the telematics unit 1000 are used to adjust the risk multipliers (as well as or instead of the thresholds used in event detection), this input data may also be sent to the back end 2000, again preferably with a time stamp, and the back end adjusts the risk multipliers as they apply to the events detected by the different telematics units 1000 before summing the risk-multiplied numbers of events in any category. Effectively, sub-categories with different risk multipliers may be created for summation into the cumulative risk.

By obtaining a count for all the events in the fleet for each category, applying the risk multipliers to the counts for the respective categories, and applying the results to obtain a cumulative risk, it is possible to determine a driving behaviour risk indicator for the fleet as a whole.

As discussed above, the cumulative risk may be integrated over, or divided by, the duration of the risk period.

For calculation of the driving behaviour risk indicator for the fleet, the cumulative risk for the fleet (whether or not integrated over time or per unit of time) may be divided by the total distance travelled by the fleet. This total distance may be obtained by summing the distances sent by each of the telematics units in the fleet or by tracking each vehicle in the fleet using GPS or other global positioning system, determining the distance travelled by each vehicle in the fleet in this way, and summing the distances travelled to obtain the total distance travelled by the fleet.

The back end 2000 may also calculate individual driving behaviour risk indicators for each vehicle and/or each driver in the fleet if this has not been done by the telematics unit. Notably, the back end 2000 may calculate a cumulative driving behaviour risk indicator for a driver even if he drives different vehicles in the fleet. The back end 2000 may also calculated driving behaviour risk indicators for subsets of drivers and/or vehicles in the fleet, for example based on routes or times driven.

Although the system has been described as though each telematics unit 1000 detects individual events and sends them to the back end 2000, rather some or all of the telematics units may instead send the input data necessary to detect events to the back end 2000, which then carries out event detection in addition to driving behaviour risk indicator calculation for the individual vehicles and/or the fleet as a whole.

Accordingly, the present invention provides as separate entities:
a unit 1000 (which may, but need not, be provided with telematics functionality);
a back end 2000; and
a system 4000, 5000 comprising the back end 2000 and one or more units 1000.

Each of these is capable of calculating one or more of a driving behaviour risk indicator for a single vehicle, an indicator for a single driver, and indicator for a fleet. Moreover, such indicators can be calculated for specific periods (risk periods). As an example, there can be calculated:
Driver Daily Indicator—a risk indicator calculated over a period of 1 day for 1 driver (1 vehicle).
Driver Monthly Score—a risk indicator calculated over a period of 1 month for 1 driver (1 vehicle).
Fleet Daily Indicator—a risk indicator calculated over a period of 1 day for a fleet of N>1 vehicles.
Fleet Monthly Score—a risk indicator calculated over a period of 1 month for a fleet of N>1 vehicles.

Naturally, if the data is held long enough, the particular risk periods can be selected to give an indication of which times and seasons are safest to drive in, and which types of events are most likely to occur at which times, so that drivers can be trained to drive more safely at risky times.

It is noted that, although preferred, it is not an essential feature of the ‘fleet’ aspect of the invention that telematics unit 1000 comprises a six degrees of freedom inertial unit 200 having a 3D inertial sensor with 3D gyroscope functionality. Rather, other types of sensor can be used. In particular, this aspect of the invention may be practised, for example, using a 3D accelerometer without gyroscope functionality.

The driving behaviour risk indicators calculated by the present invention may be advantageously be used by vehicle insurance companies to estimate the risk posed by individual drivers, the collective risk on a vehicle driven by named drivers, and the risk on a fleet of vehicles as well as individual vehicles and drivers within the fleet. In addition, the driving behaviour risk indicators can be used by insurers and fleet owners and operators to establish which vehicles or makes of vehicles are safest to drive, as well as which times and routes are safest, and which drivers should be singled out for additional safety training or in worst cases disciplinary action. The driving behaviour risk indicators will also be of interest to individuals, families, vehicle manufacturers and government departments.

The foregoing description has been given by way of example only and it will be appreciated by a person skilled in the art that modifications can be made without departing from the scope of the present invention.

In particular, detailed algorithms have been explained for harsh acceleration, harsh braking, harsh cornering, over-steering, evasive manoeuvring, speed variance and driving without a break, each of which may be considered innovative by itself. However, it should be appreciated that variations in each algorithm are possible whilst remaining within the scope of the invention.

For example, it is possible to remove the vehicle velocity threshold tests or not to use the flags/Boolean variables in any or all of the algorithms described above. In addition, rather than using averaged values (such as averaged longitudinal acceleration), other measures such as maximum values and median values may be used.

In another embodiment, the present invention provides for the reconstruction of the trajectory of a vehicle, particularly but not exclusively in the case where the vehicle has crashed.

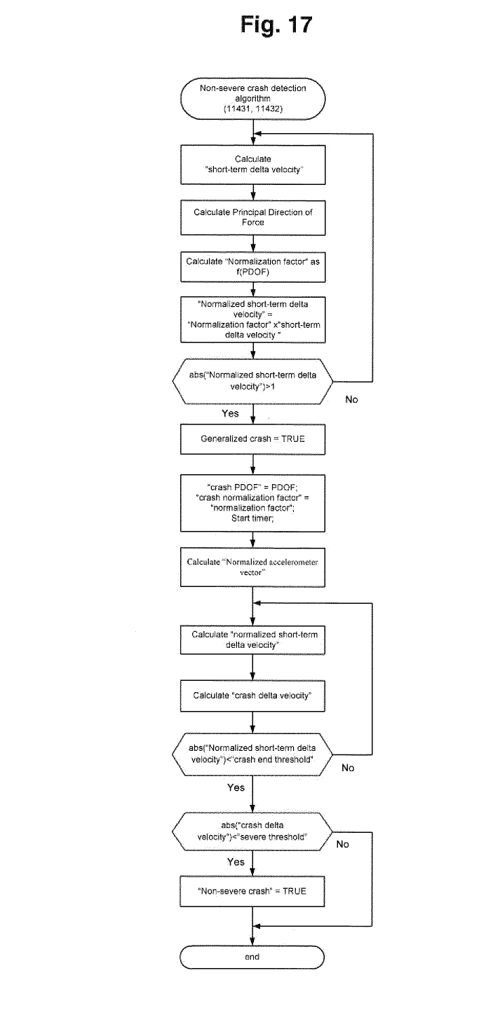

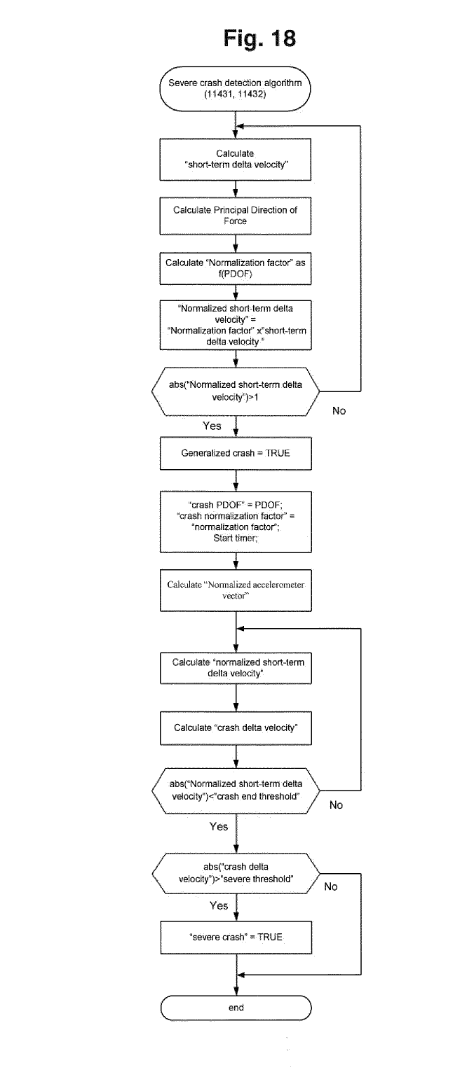

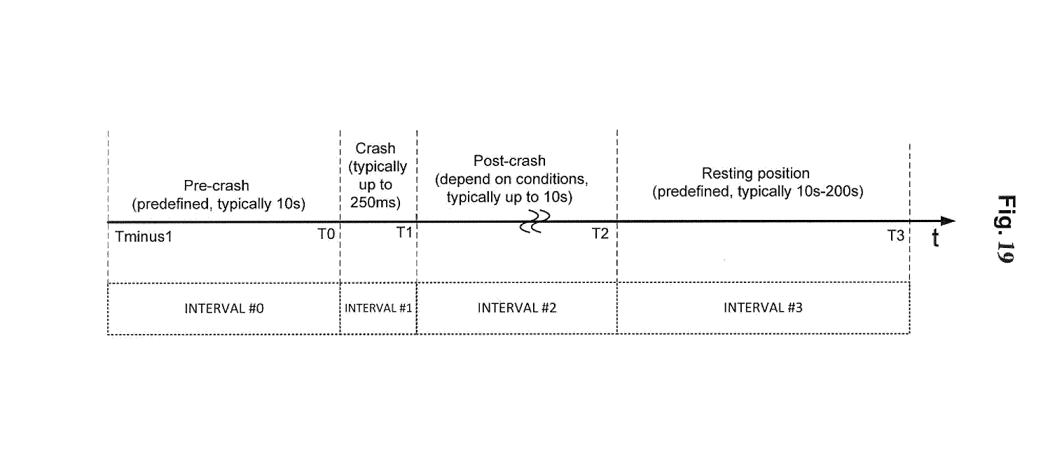

The detection of crashes, for example using accelerometers is well-known and, where such detection is required, any known method can be used. In the present invention, it is preferred that the detection of crash events is carried out as described below with reference to FIGS. 17 and 18.

In particular, severe and non-severe crash events are distinguished. The detection of non-severe crash events is shown in FIG. 17 and is based on monitoring of a change of the velocity vector during a short-term window. The acceleration vector is continuously integrated over a predefined time-window. In parallel, the algorithm calculates a principal direction of force (PDOF) in the horizontal and vertical planes. The PDOF determines the value of a normalization factor, which is used to normalize this change of the velocity vector. In particular, the normalisation factor is a function of the PDOF. At the moment when this normalized change of the velocity vector exceeds a threshold pre-set to 1 (as all inputs were normalized) a general crash is detected and the calculated PDOF is recorded as a “crash PDOF”. This triggers a process of accumulation of the changes of velocity vector along with a start of a timer to determine the crash duration. A short-term integration of the acceleration vector is continued until it falls below a predefined crash-end threshold that marks an end of the crash event. If the cumulative change of the velocity vector during the crash interval is below a threshold defined for severe-crash events, this crash is automatically considered as a non-severe. If the device detects multiple crashes or a crash with a roll-over or there is another indication of an entrapment of passengers, the final change of speed is increased and re-compared to the threshold.

Similarly, the detection of severe events is shown in FIG. 18 and is based on monitoring of the change of the velocity vector during a short-term window. The acceleration vector is continuously integrated over a predefined time-window. In parallel, the algorithm calculates the principal direction of force (PDOF) in the horizontal and vertical planes. Again the PDOF determines the value of normalization factor, which is used to normalize this change of the velocity vector. At a moment when this normalized change of the velocity vector exceeds a threshold pre-set to number 1 (as all inputs were normalized) a general crash is detected and the calculated PDOF is recorded as a “crash PDOF”. This triggers the process of accumulation of change of velocity vector along with a start of timer to determine the crash duration. A short-term integration of the acceleration vector is continued until it falls below a predefined crash-end threshold that marks an end of the crash event. If the cumulative change of the velocity vector during the crash interval is above a threshold defined for severe-crash events, this crash is automatically considered as severe. If the device detects multiple crashes or a crash with roll-over or there is another indication of an entrapment of passengers, a final change of speed is increased and re-compared to the threshold. After this, an additional stratification may be performed to classify the crash as having a medium (25-75%) and high (>75%) probability of being a severe crash.

In the present embodiment, vehicle trajectory reconstruction may be carried out if it is determined that a severe crash event has occurred, or if there is a sufficiently high probability that such an event has occurred. However, trajectory reconstruction may be carried out at any desired time and the following description of trajectory reconstruction is applicable.

The time line of typical crash is shown in FIG. 19, in which a crash event is separated into four distinct periods:
interval 0 between times T−1 and T0, which may be defined as a set period, for example 10 seconds, before a crash event occurs;
interval 1 between times T0 and T1, in which large forces instantaneously act on the vehicle at the start of a crash, typically lasting up to 250 ms;
interval 2 between times T1 and T2, which immediately follows and in which smaller forces act on the vehicle as it travels from the start of the crash towards its final resting place, typically lasting around 10 seconds; and
interval 3 between times T2 and T3, which may be defined as a set period, for example from 10 second to 10 minutes, in which the vehicle is in its resting position after the crash. Using a long duration for interval 3 has the benefit that good averages can be taken over the longer duration, as discussed below. In a preferred embodiment, interval 3 is determined as the period starting when it is detected that the vehicle is in a steady state (not moving) plus a predetermined time.

Accelerometers and dead-reckoning systems that use them are subject to drift in their output. In particular, because any system using them is continually adding detected changes to its previously-calculated positions or outputs of velocity, angular velocity, acceleration and angular acceleration, any errors in measurement, however small, are accumulated from point to point. This leads to ‘drift’, or an ever-increasing difference between where the system thinks it is located, and the actual location.

Moreover, the bias, or bias error, of a rate gyro is the signal output from the gyro when it is not experiencing any rotation. Even the most perfect gyros have error sources and bias is one of these errors. Bias can be expressed as a voltage or a percentage of full scale output, but essentially it represents a rotational velocity (in degrees per second). Unfortunately bias error tends to vary, both with temperature and over time. The bias error of a gyro is due to a number of components: calibration errors; switch-on to switch-on; bias drift; and effects of shock, which may be significant in crashes. Individual measurements of bias are also affected by noise, so a meaningful bias measurement may be taken as an averaged series of measurements. In addition, the bias may vary over time, assuming all other factors remain constant.

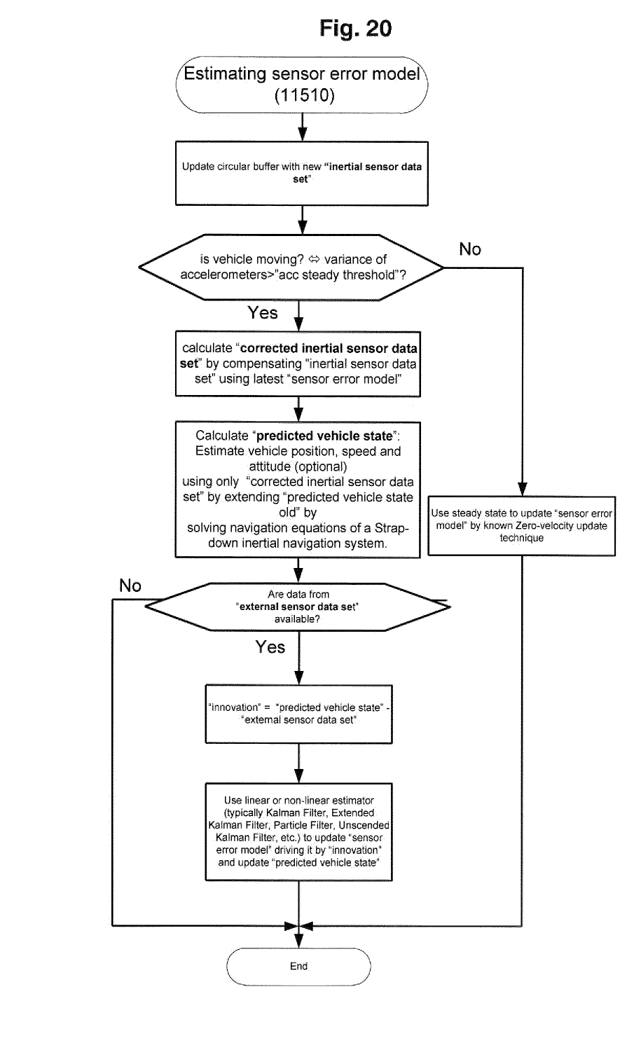

Accordingly, during normal operation of the vehicle, a regularly updated sensor error model operates to estimate error and correct bias and drift in the output of the inertial sensor unit, which comprises a 3D inertial sensor with 3D gyroscope functionality. This is shown in FIG. 20.

In the first box, the output from the inertial sensor unit 200 is stored in a circular buffer at a predetermined sampling rate. At each update, it is determined whether the vehicle is moving by querying whether the variance in the accelerometers is larger than a predetermined “acc steady threshold”. If the vehicle is not moving, the vehicle's steady state is used to update the sensor error model using a zero velocity update technique. The algorithm then returns to the beginning and awaits the next sample of data from the inertial sensor unit.

Alternatively, if the vehicle is moving or optional determination of whether the vehicle is moving is omitted, previously determined parameters are used to compensate this inertial sensor data set using the current sensor error model and the compensated data set is then used to calculate the predicted vehicle state—position and attitude in three dimensions—roll, pitch and yaw—scalar velocity information, scalar acceleration information, velocity vector changes, acceleration vector changes etc. In particular, the sensor error model comprises a number of mathematical algorithms using various parameters/variables to compensate for accelerometer biases, accelerometer scale factors, accelerometer cross-axis compensation, gyroscope bias, gyroscope scale factors, gyroscope drift, (if provided, odometer speed scale factor, magnetometer scale factor, magnetometer bias) and so forth.

In the decision box, it is checked whether data from an external sensor data set has been received. Generally, such external data will comprise position data received by the global positioning receiver system 110, but may also comprise other data, such as attitude data in three axes from external sensors, for example when the vehicle is at rest. If no external data has been received, the system continues without correcting the sensor error model.

However, if external data has been received, this is compared with the predicted state of the vehicle. For example, if satellite positioning data is received at intervals between 0.1 seconds and 1 second, the telematics unit 1000 calculates the difference(s) between the predicted position based on the corrected outputs from the inertial sensor unit and the position given by the satellite positioning data. Similarly, the difference(s) between the predicted attitude and external attitude data may be determined. This difference is termed “innovation” in FIG. 20.

Subsequently, the “innovation” variable(s) is/are used to update the parameters of the sensor error model that correct for sensor biases, scale factors, gyro scale factors, gyro biases, cumulative drifts and so forth. In particular, a linear or non-linear estimator (which may include any of Kalman filters, extended Kalman filters (EKFs), particle filters, and unscended Kalman filters) is used to update the sensor error model based on the “innovation” variable(s).

The updated sensor error model is then used to update the predicted vehicle state and the process ends until the next cycle for the next sample.

A plurality of sensor error models are stored in a circular buffer, the plurality being updated on regular basis, say every 0.1 seconds or every second.

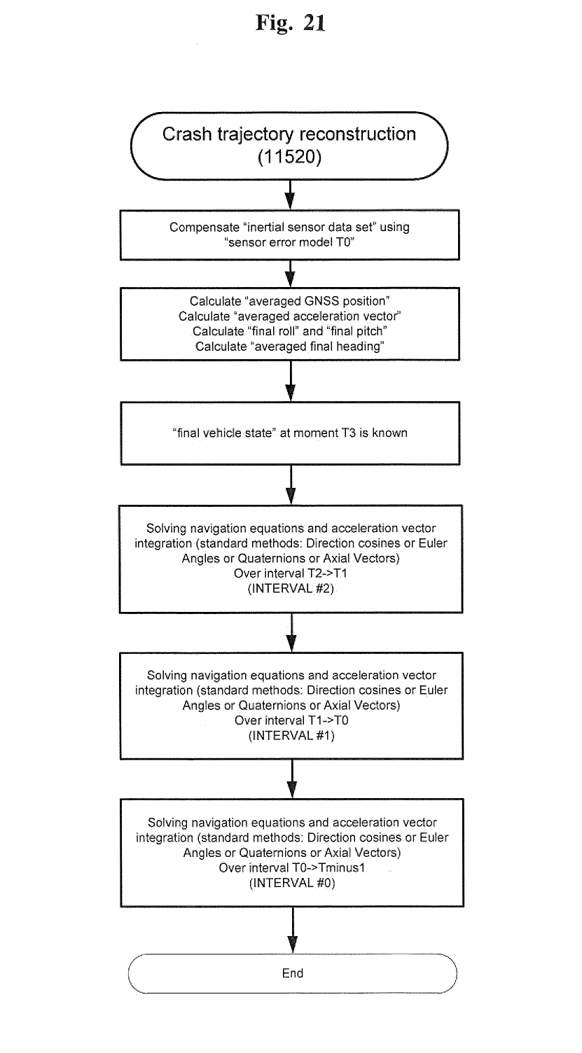

The determination of crash trajectory reconstruction of the present invention is shown in FIG. 21. Before reconstruction begins, it is determined that interval 3 in FIG. 19 has expired, for example if there has been no or little change in the outputs of the inertial sensor unit 200 or, more preferably, a preset time has expired. Then, the inertial sensor model operative at time T0 is used to compensate the inertial data set stored in the circular buffer at time T3, and all inertial data sets stored in the whole of the recorded interval between T0 and T3, will be compensated with the sensor error model from T0. Compensation of gyro drifts can be further improved as the steady state enables this. In particular, it is possible to determine time T0 at the start of the crash and to retrieve and apply the sensor error model operative at that time. This sensor error model will still be valid as little time has passed since the start of the crash, but the model will not be affected by sudden accelerations during the crash.

Subsequently, the averaged GNSS position (satellite-determined position), averaged acceleration vector and averaged final heading are calculated over interval 3. The final, resting attitude of the vehicle of the vehicle is also determined from the compensated inertial sensor data set (which may include the final yaw as well as the final roll and final pitch).

As indicated in FIG. 20, the final vehicle state at time T3 is known. This can be determined externally from GNSS (or another satellite navigation system) data or averaged GNSS data taken for the vehicle in its final resting position, or otherwise measured externally. It is also preferred to obtain externally determined, accurate roll, pitch and possibly yaw measurements.

Based on this externally determined final vehicle state, the averaged GNSS position, the averaged acceleration vector, the averaged final heading and the final roll and final pitch, as well as the inertial sensor data set corrected using the sensor error model at time T0, it is possible reconstruct the trajectory of the vehicle by determining the vehicle state—position and attitude in three dimensions (roll, pitch and optionally yaw), scalar velocity information, scalar acceleration information, velocity vector changes, acceleration vector changes etc. The vehicle state can be calculated for each compensated inertial sensor data set stored in the circular buffer, starting at time T2 and working backwards through interval 2 back to time T1, interval 1 back to time T0, and interval 0 back to time T−1. In particular, the vehicle state can be determined by solving equations and acceleration vector integration for example by the using direction cosines, Euler angles, quaternions and/or axial vectors.

Since the final resting position of the vehicle is known, the vehicle states can be accurately matched to the specific positions on the road at which they occur, and an accurate forensic analysis can be determined. Moreover, it is possible to send to a user the calculated vehicle states and provide a reconstruction in three dimensions of the vehicle's trajectory (position, velocity vector, attitude) before and during the crash.

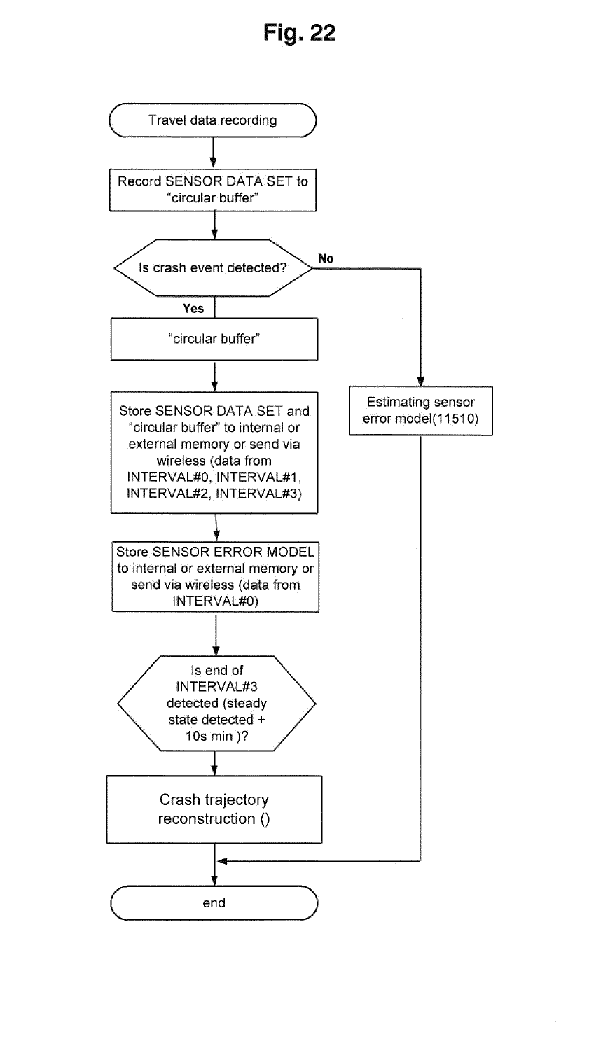

As previously noted, the telematics unit 1000 continually updates the circular buffer with inertial sensor data sets. An exemplary regime for recording inertial sensor data sets is shown in FIG. 22. If a crash is detected, the sampling rate may be increased at or after time T0 or otherwise varied. In addition, sampling may cease after time T3.

In addition, the telematics functions of the unit 1000 are optional for trajectory reconstruction, the relevant data being accessible to the investigator or other user by Wi-Fi, USB interface etc. However, if telematics functionality is provided, the unit 1000 may automatically send any and all data relevant to trajectory reconstruction to a remote processing entity (including inertial sensor data sets, sensor error models, and trajectory calculations) during or after the crash. The unit may also be configured to store such data in an especially secure memory that is less susceptible to the shocks and damage that might otherwise be occasioned by a crash.

The trajectory may be reconstructed in the unit 1000, the remote processing entity 2000 or another processing device, for example a laptop computer, which retrieves the necessary information from the unit 1000 wireless or via a wired interface.

The foregoing description has been given by way of example only and it will be appreciated by a person skilled in the art that modifications can be made without departing from the scope of the present invention.

1. An apparatus for calculating a driving behaviour risk indicator for a driver of a vehicle, comprising:
a processing and control unit; and
a memory,
the apparatus being adapted to:
obtain a count of events occurring in each of a plurality of predetermined categories based on inputs from an inertial unit mounted on the vehicle, the inertial unit including a 3D inertial sensor with 3D gyroscope functionality, each event being indicative of at least one of dangerous and aggressive driving; and
calculate a driving behaviour risk indicator based on the number of events in each category.

2. An apparatus according to claim 1, a respective weighting factor being stored in the memory for each category and the apparatus being adapted to calculate the driving behaviour risk indicator by applying the respective weighting factor to the number of events in each category.

3. An apparatus according to claim 1, being adapted to calculate the driving behaviour risk indicator based on the number of events occurring in a predetermined period.

4. An apparatus according to claim 3, being adapted to calculate the driving behaviour risk indicator based on the duration of the predetermined period.

5. An apparatus according to claim 3, being adapted to calculate the driving behaviour risk indicator based on the distance travelled during the predetermined period.

6. An apparatus according to claim 1, being adapted to calculate the driving behaviour risk indicator by:
obtaining the number of events occurring in a predetermined period in each category;
applying a respective weighting factor to the number of events occurring in the predetermined period in each category;
summing the weighted numbers of events in all categories to obtain a cumulative risk for the predetermined period;
determining the distance travelled by the vehicle during the predetermined period; and
dividing the cumulative risk by the distance travelled.

7. An apparatus according to claim 6, being adapted to modify the cumulative risk for the predetermined period based on the duration of the period.

8. An apparatus according to claim 1, being adapted to modify the driving behaviour risk indicator based on environmental data.

9. An apparatus according to claim 8; the environmental data including at least one of road data, temperature data, ambient weather data and geographical position data.

10. An apparatus according to claim 1, predetermined categories comprising any two or more of harsh cornering, over-steering, and evasive manoeuvring.

11. An apparatus according to claim 1, the apparatus being mountable in a vehicle.

12. An apparatus according to claim 11, comprising the inertial unit.

13. An apparatus according to claim 11, further comprising a transmitter and a receiver for communicating with a remote processing entity.

14. An apparatus according to claim 1,
the apparatus being remote from the vehicle;
the events in each category being detected on the vehicle; and
the apparatus being adapted to obtain the count by receiving from the vehicle at least one of:
data in respect of each event, and
the count of events in each category.

15. An apparatus according to claim 1, the apparatus being:
remote from the vehicle; and
adapted to obtain the count by receiving and processing inputs from an inertial unit mounted on the vehicle.

16. An apparatus according to claim 14, adapted to obtain a count of events, occurring in each of a plurality of predetermined categories, for each of a plurality of different vehicles in a fleet and to determine driving behaviour risk indicator for the fleet.

17. An apparatus according to claim 16, further adapted to compare the driving behaviour risk indicator for a single vehicle with at least one of the driving behaviour risk indicator of the fleet and an alternatively obtained comparative driving behaviour risk indicator.

18. An apparatus according to claim 16, further adapted to compare the driving behaviour risk indicator of the fleet with an alternatively obtained comparative driving behaviour risk indicator.

19. A system comprising a processing entity and a plurality of apparatuses according to claim 11, the processing entity communicating with each of the plurality of apparatuses by means of a long range wireless network.

20. A system comprising a plurality of telematics units mounted on respective vehicles and a remote processing unit, wherein:
the telematics units comprise an inertial sensor unit;
at least one of the remote processing entity and the telematics units is adapted to obtain a count of events occurring in each of a plurality of predetermined categories based on inputs from the inertial sensor unit, each event being indicative of at least one of dangerous and aggressive driving; and
the remote processing entity is adapted to calculate a combined driving behaviour risk indicator for the plurality of telematics units based on the number of events in each category.

21. A system according to claim 20, the inertial sensor unit including a 3D inertial sensor with 3D gyroscope functionality.

22. A system according to claim 20, at least one of the remote processing entity and each telematics unit being adapted to calculate a driving behaviour risk indicator.

23. A method of calculating a driving behaviour risk indicator for a driver of a vehicle, comprising:
detecting events occurring in each of a plurality of predetermined categories based on inputs from an inertial unit mounted on the vehicle, the inertial unit including a 3D inertial sensor with 3D gyroscope functionality, each event being indicative of at least one of dangerous and aggressive driving; and
calculating a driving behaviour risk indicator based on the number of events in each category.

24-37. (canceled)

38. A method of determining a driving behaviour risk indicator for a plurality of vehicles, the method comprising:
detecting events occurring in each of a plurality of predetermined categories based on inputs from an inertial unit mounted on each said vehicle, each event being indicative of at least one of dangerous and aggressive driving; and
calculating a driving behaviour risk indicator for the plurality of vehicles based on the number of events in each category.

39-61. (canceled)
